(19) United States
(12) Patent Application Publication
(10) Pub. No.: US 2024/0073385 A1
(43) Pub. Date: Feb. 29, 2024

(54) DISPLAY CONTROL METHOD, CONTROL DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Shiki FURUI, Matsumoto-shi (JP)

(21) Appl. No.: 18/455,818

(22) Filed: Aug. 25, 2023

(30) Foreign Application Priority Data
Aug. 26, 2022 (JP) 2022-134740

(51) Int. Cl. H04N 9/31

(52) U.S. Cl. CPC H04N 9/3185

(57) ABSTRACT

A display control method includes: changing a display mode of a target image when an instruction image is located in a control region of the target image that includes a display position where the target image is displayed, the target image being one of a plurality of control images for correcting a projection image projected by a projector.

The present application is based on, and claims priority from JP Application Serial Number 2022-134740, filed Aug. 26, 2022, the disclosure of which is hereby incorporated by reference herein in its entirety.

### BACKGROUND

### 1. Technical Field

The present disclosure relates to a display control method, a control device, and a non-transitory computer-readable storage medium storing program.

### 2. Related Art

An image projection system that performs image correction of a projection image projected by a projector is known. In an image projection system described in JP-A-2009-182436, a user performs image correction on a projection image by using a computer. The computer is connected to a projector via a network line. The computer displays a setting screen on a display. The user operates a cursor displayed on the setting screen by operating an information input device. The user operates the cursor to operate a vertex mark or the like of a picture image displayed on the setting screen.

When a plurality of operable images are displayed on the setting screen or when the display of the setting screen is small, the user has difficulty in checking whether the cursor is located at a position corresponding to a desired image.

### SUMMARY

A display control method according to the present disclosure includes: changing a display mode of a target image when an instruction image is located in a control region of the target image that includes a display position where the target image is displayed, the target image being one of a plurality of control images for correcting a projection image projected by a projector.

A control device according to the present disclosure includes: one or more processors configured to display an instruction image and a plurality of control images for correcting a projection image projected by a projector, and change a display mode of a target image when the instruction image is located in a control region of the target image that includes a display position where the target image is displayed, the target image being one of the plurality of control images; and an interface circuit configured to receive an operation for the instruction image.

A non-transitory computer-readable storage medium storing a program according to the present disclosure, the program causing a processor to: display an instruction image and a plurality of control images for correcting a projection image projected by a projector; receive an operation for the instruction image; and change a display mode of a target image when the instruction image is located in a control region of the target image that includes a display position where the target image is displayed, the target image being one of the plurality of control images.

### BRIEF DESCRIPTION OF THE DRAWINGS

FIG. 1 is a diagram illustrating a schematic configuration of a display system.

FIG. 2 is a diagram illustrating a block configuration of the display system.

FIG. 3 is a diagram illustrating a schematic configuration of a projection unit.

FIG. 4 is a flowchart of geometric distortion correction.

FIG. 5 is a diagram illustrating an outline of a comparison image projected onto a projection surface.

FIG. 6 is a diagram illustrating a configuration of a management screen.

FIG. 7 is a diagram illustrating a configuration of a management screen.

FIG. 8 is a diagram illustrating a schematic configuration when a part of a preview image is displayed in an enlarged manner.

FIG. 9 is a diagram illustrating a schematic configuration when a part of the preview image is displayed in an enlarged manner.

FIG. 10 is a diagram illustrating a schematic configuration when a part of the preview image is displayed in an enlarged manner.

FIG. 11 is a flowchart of display control.

FIG. 12 is a diagram illustrating a schematic configuration when a part of the preview image is displayed in an enlarged manner.

FIG. 13 is a diagram illustrating a schematic configuration when a part of the preview image is displayed in an enlarged manner.

FIG. 14 is a diagram illustrating a schematic configuration when a part of the preview image is displayed in an enlarged manner.

FIG. 15 is a diagram illustrating a schematic configuration when a part of the preview image is displayed in an enlarged manner.

FIG. 16 is a diagram illustrating a schematic configuration when a part of the preview image is displayed in an enlarged manner.

FIG. 17 is a flowchart of display control.

FIG. 18 is a diagram illustrating a schematic configuration when a part of the preview image is displayed in an enlarged manner.

FIG. 19 is a diagram illustrating a schematic configuration when a part of the preview image is displayed in an enlarged manner.

FIG. 20 is a diagram illustrating a schematic configuration when a part of the preview image is displayed in an enlarged manner.

FIG. 21 is a diagram illustrating a schematic configuration when a part of the preview image is displayed in an enlarged manner.

FIG. 22 is a diagram illustrating a schematic configuration when a part of the preview image is displayed in an enlarged manner.

FIG. 23 is a diagram illustrating a configuration of the management screen.

FIG. 24 is a diagram illustrating a configuration of the management screen.

### DESCRIPTION OF EMBODIMENTS

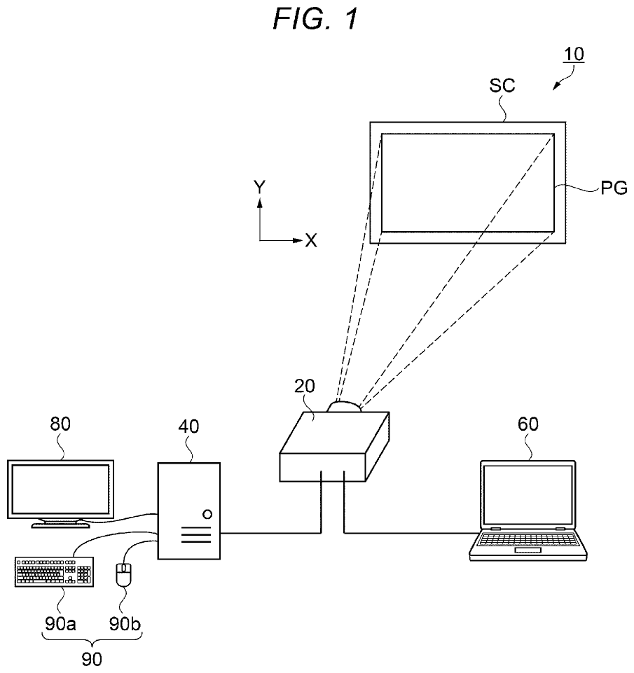

FIG. 1 illustrates a schematic configuration of a display system 10. The display system 10 includes a projector 20, a display control device 40, and an image-providing device 60. The projector 20 projects a projection image PG onto a projection surface SC. The display control device 40 is communicably connected to a display 80 and an input device 90. FIG. 1 illustrates a keyboard 90a and a mouse 90b as the input device 90. The display system 10 illustrated in FIG. 1 includes one projector 20, and is not limited thereto. The display system 10 may include a plurality of projectors 20.

The projector 20 projects the various projection images PG onto the projection surface SC. The projector 20 is communicably connected to the display control device 40 and the image-providing device 60. The projector 20 projects the projection image PG onto the projection surface SC based on display data received from the display control device 40 or image data received from the image-providing device 60. The projector 20 corresponds to an example of a projection device.

The display control device 40 generates image correction data for correcting the projection image PG projected by the projector 20. The display control device 40 is communicably connected to the projector 20. The display control device 40 transmits the display data, the image correction data, and the like to the projector 20. The projector 20 projects the projection image PG onto the projection surface SC based on the display data. The projector 20 corrects, based on the image correction data, the projection image PG projected onto the projection surface SC. The display control device 40 corresponds to an example of a control device. The display control device 40 is, for example, a personal computer.

The display control device 40 displays various images on the display 80. A user performs an input operation on the image displayed on the display 80. The display control device 40 generates the image correction data by using input data input by the input operation of the user.

The image-providing device 60 provides the image data to the projector 20. The image-providing device 60 transmits the image data to the projector 20. The projector 20 projects the projection image PG based on the image data received from the image-providing device 60 onto the projection surface SC. The projector 20 may correct the image data by using the image correction data received from the display control device 40. The projector 20 projects the projection image PG based on the image data corrected by the image correction data onto the projection surface SC. The display system 10 illustrated in FIG. 1 includes the image-providing device 60, and is not limited thereto. The display control device 40 may function as the image-providing device 60.

The projection surface SC displays the projection image PG projected by the projector 20. The projection surface SC displays the various projection images PG. The various projection images PG include a comparison image CG to be described later. The comparison image CG is projected onto the projection surface SC based on the display data transmitted from the display control device 40 to the projector 20. The projection surface SC is a surface of an object onto which the projection image PG is projected. The projection surface SC may have a three-dimensional shape such as a surface having unevenness or a curved surface. The projection surface SC may be implemented by a screen or the like. FIG. 1 illustrates an X axis and a Y axis. The X axis and the Y axis are axes on the projection surface SC orthogonal to each other.

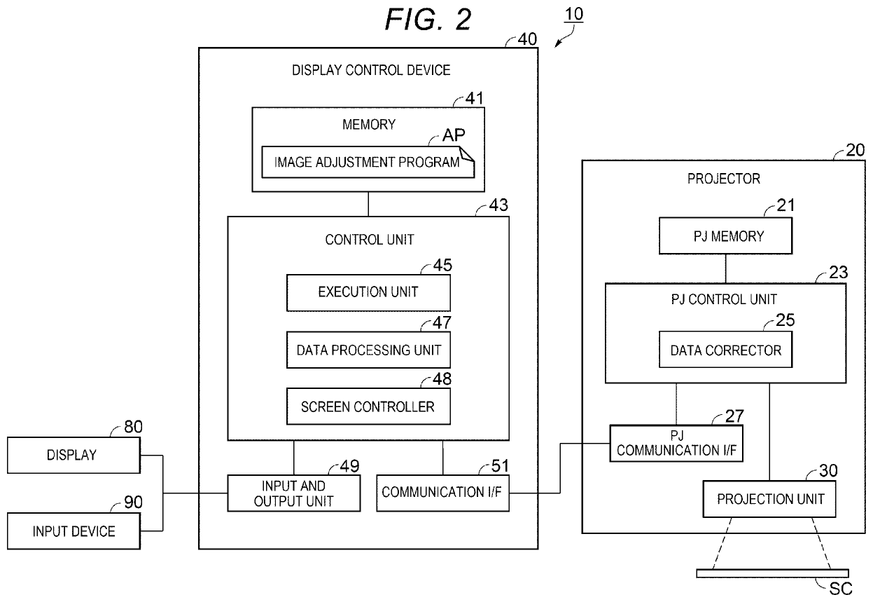

FIG. 2 illustrates a block configuration of the display system 10. In the display system 10 illustrated in FIG. 2, the image-providing device 60 is omitted. FIG. 2 illustrates the projector 20, the display control device 40, the display 80, and the input device 90. FIG. 2 illustrates the projection surface SC onto which the projector 20 projects the projection image PG.

The projector 20 includes a PJ memory 21, a PJ control unit 23, a PJ communication interface 27, and a projection unit 30. In FIG. 2, an interface is represented as an I/F.

The PJ memory 21 stores various types of data. The PJ memory 21 stores the image correction data transmitted from the display control device 40, the display data transmitted from the display control device 40, the image data transmitted from the image-providing device 60, and the like. The PJ memory 21 may store various projector control programs that operate in the PJ control unit 23. The PJ memory 21 includes a read only memory (ROM), a random access memory (RAM), and the like.

The PJ control unit 23 is a projector controller that controls the projector 20. The PJ control unit 23 is, for example, a processor including a central processing unit (CPU). The PJ control unit 23 may be implemented by one or more processors. The PJ control unit 23 may include a semiconductor memory such as a RAM or a ROM. The semiconductor memory functions as a work area of the PJ control unit 23. The PJ control unit 23 functions as a data corrector 25 by executing the projector control program stored in the PJ memory 21.

The data corrector 25 corrects the display data, the image data, and the like. The data corrector 25 performs various types of correction on the display data or the image data such as edge blending, geometric distortion correction, and image quality adjustment. The data corrector 25 corrects the image data and the like by using the image correction data stored in the PJ memory 21. The data corrector 25 may divide the image data and the like into unit regions and perform the correction for each unit region.

The PJ communication interface 27 receives various types of data such as the image data, the display data, and the image correction data. The PJ communication interface 27 is communicably connected to an external device such as the display control device 40 and the image-providing device 60. The PJ communication interface 27 is connected to the external device in a wired or wireless manner according to a predetermined communication protocol. The PJ communication interface 27 includes, for example, a wired-communication connecting port, a wireless-communication antenna, and an interface circuit. The PJ communication interface 27 receives the display data, the image correction data, and the like from the display control device 40. The PJ communication interface 27 receives the image data and the like from the image-providing device 60. The PJ communication interface 27 may transmit various types of data to the display control device 40 and the image-providing device 60.

The projection unit 30 projects the projection image PG onto the projection surface SC. The projection unit 30 projects the projection image PG onto the projection surface SC under the control of the PJ control unit 23. A schematic configuration of the projection unit 30 will be described later.

The display control device 40 includes a memory 41, a control unit 43, an input and output unit 49, and a communication interface 51. The display control device 40 is connected to the display 80 and the input device 90 via the input and output unit 49.

The memory 41 stores various types of data, various control programs, and the like. The memory 41 stores the display data, the image correction data, and the like generated by the control unit 43. The memory 41 stores a control program that operates in the control unit 43. The control program stored in the memory 41 includes an image adjustment program AP. The memory 41 includes an ROM, an RAM, and the like. The memory 41 may further include a magnetic storage device such as a hard disk drive (HDD), a semiconductor memory, and the like. The memory 41 corresponds to an example of a storage medium.

The control unit 43 is a controller that performs various types of processing. The control unit 43 generates screen data. The screen data causes the display 80 to display a display screen. The display screen includes a plurality of display images. The control unit 43 generates the image correction data for correcting the projection image PG projected by the projector 20. The control unit 43 transmits the comparison image data to the projector 20 via the communication interface 51. The comparison image data is display data for projecting the comparison image CG onto the projection surface SC by the projector 20. The comparison image CG will be described later. The control unit 43 is, for example, a processor including a CPU. The control unit 43 may be implemented by one or more processors. The control unit 43 may include a semiconductor memory such as a RAM or a ROM. The semiconductor memory functions as a work area of the control unit 43. The control unit 43 functions as a functional unit by executing the control program stored in the memory 41. The control unit 43 corresponds to an example of a display controller.

The control unit 43 functions as an execution unit 45, a data processing unit 47, and a screen controller 48 by operating the image adjustment program AP stored in the memory 41. The image adjustment program AP causes the display 80 to display a management screen 100. The management screen 100 is an example of the display screen. The user corrects the projection image PG projected by the projector 20 by performing an input operation on the management screen 100. The image adjustment program AP causes, based on the input operation performed by the user, the control unit 43 to generate the image correction data for correcting the projection image PG. The image adjustment program AP corresponds to an example of a program.

The control unit 43 functions as the execution unit 45, the data processing unit 47, and the screen controller 48 by executing the image adjustment program AP. The execution unit 45, the data processing unit 47, and the screen controller 48 are the functional units. The control unit 43 functions as the functional unit to generate management screen data for displaying the management screen 100 on the display 80. The management screen data is an example of the screen data.

The execution unit 45 performs various types of control based on the input data. The execution unit 45 acquires the input data via the input and output unit 49. The input data is data output by the input device 90 such as the keyboard 90a and the mouse 90b. The input data includes coordinate information on a cursor 200, an operation signal, and the like. The cursor 200 is displayed on the display 80. The cursor 200 is operated by the mouse 90b or the like.

The execution unit 45 detects a display position of the cursor 200 on the display screen based on the input data. The execution unit 45 detects the display position of the cursor 200 on the display screen based on the coordinate information on the cursor 200 included in the input data. The execution unit 45 transmits the detected display position of the cursor 200 to the data processing unit 47 or the screen controller 48. The execution unit 45 determines, based on the operation signal included in the input data, an input instruction corresponding to the input operation performed by the user. The input instruction includes a selection instruction, a selection release instruction, a lock instruction, a lock release instruction, and a movement instruction. The execution unit 45 transmits the determined input instruction to the data processing unit 47 or the screen controller 48.

The execution unit 45 generates the comparison image data to be transmitted to the projector 20. The comparison image data is display data for projecting the comparison image CG onto the projection surface SC by the projector 20. The execution unit 45 transmits the generated comparison image data to the projector 20 via the communication interface 51.

The execution unit 45 executes various types of control processing on grid lines 145 and grid points 147. The execution unit 45 executes the various types of control processing on the grid lines 145 or the grid points 147 based on the determined input instruction. Examples of the various types of control processing include selection processing, selection release processing, lock processing, lock release processing, and movement processing. The control processing is processing corresponding to the input instruction. For example, the selection processing is control processing performed in response to the selection instruction. When executing the various types of control processing, the execution unit 45 generates user setting data including processing results of the various types of processing. The execution unit 45 transmits the generated user setting data to the data processing unit 47 and the screen controller 48.

The data processing unit 47 generates the image correction data for correcting the projection image PG. The data processing unit 47 generates the image correction data based on the user setting data received from the execution unit 45. The data processing unit 47 transmits the generated image correction data to the communication interface 51. The data processing unit 47 may transmit the generated image correction data to the memory 41. The memory 41 stores the received image correction data.

The image correction data is data for performing the various types of correction such as the geometric distortion correction. The geometric distortion correction is processing of correcting a distortion of the projection image PG. The distortion of the projection image PG occurs when the projection surface SC is a curved surface or when the projection surface SC has unevenness. The distortion of the projection image PG occurring in the latter case occurs when the projector 20 projects the projection image PG from a position other than front of the projection surface SC. The image correction data is generated based on the input data input by the input operation performed by the user. The image correction data is used for adjusting the distortion of the projection image PG projected onto the projection surface SC.

The screen controller 48 displays the cursor 200 on the display screen. The cursor 200 is operated by a cursor operation performed by the user. The cursor operation is an example of the input operation performed by the user. The user changes the display position of the cursor 200 by the cursor operation. The screen controller 48 displays the cursor 200 at a position changed by the cursor operation of the user. The cursor 200 corresponds to an example of an instruction image. The cursor operation corresponds to an example of an operation for the instruction image.

The screen controller 48 performs display control on the display screen displayed on the display 80 or the display image included in the display screen. The screen controller 48 generates the screen data for displaying the display screen. The screen data includes display image data for displaying the display image. The screen controller 48 transmits the generated screen data to the display 80 via the input and output unit 49. The screen controller 48 displays the display screen based on the screen data on the display 80.

The screen controller 48 performs the display control on the display image based on the display position of the cursor 200. The display image includes the grid lines 145 and the grid points 147. The screen controller 48 acquires the display position of the cursor 200 transmitted from the execution unit 45. The screen controller 48 determines whether the display position of the cursor 200 is located in a predetermined display image region. The display image region is a region including an image display position that is a display position of the display image. The display image region is set in advance for the display image.

When the screen controller 48 determines that the cursor 200 is located in the display image region, the screen controller 48 performs the display control of changing a display mode of the display image in the display image region. The display mode includes a shape, a color, and temporal display of the display image, display of a mark image 220, and the like. The screen controller 48 generates the screen data for changing the display mode of the display image. The screen controller 48 transmits the generated screen data to the display 80 via the input and output unit 49. The display 80 displays the display screen based on the received screen data.

The display screen may include a plurality of display images. In each of the plurality of display images, a display image region including an image display position of the display image is set in advance. When acquiring the display position of the cursor 200, the screen controller 48 specifies one of the plurality of display images as a target display image. The target display image is a display image included in the display image region corresponding to the display position of the cursor 200. When specifying the target display image, the screen controller 48 performs the display control of changing a display mode of the target display image. The screen controller 48 corresponds to an example of the display controller.

The screen controller 48 changes the screen data based on the user setting data generated by the execution unit 45. When changing the screen data, the screen controller 48 transmits the changed screen data to the display 80. The screen controller 48 changes the display screen displayed on the display 80 by transmitting the changed screen data to the display 80.

The input and output unit 49 is connected to various devices such as the display 80 and the input device 90, and transmits and receives various types of data to and from the various devices. The input and output unit 49 is an input and output interface connected to the various devices, and includes an interface circuit. The input and output unit 49 includes one or more connecting ports such as a communication port and a display port of a universal serial bus (USB) standard. The input and output unit 49 illustrated in FIG. 2 is connected to the display 80 and the input device 90. The input and output unit 49 transmits the screen data to the display 80. The input and output unit 49 receives the input data received from the input device 90. By receiving the input data, the input and output unit 49 receives the input operation performed by the user. The input and output unit 49 receives the screen data generated by the screen controller 48 and transmits the screen data to the display 80. The input and output unit 49 transmits the received input data to the data processing unit 47. The input and output unit 49 corresponds to an example of a receiver.

The input data is data corresponding to the input operation performed by the user. The input data is output when the user performs the input operation by using the input device 90. The input data is an operation signal output when the user performs various input operations by using the input device 90. The operation signal is a click signal, a double-click signal, a drag signal, or the like. The input data includes the coordinate information. The coordinate information is position information on the cursor 200 when the user performs the input operation.

The communication interface 51 is communicably connected to an external device such as the projector 20. The communication interface 51 is connected to the external device in a wired or wireless manner according to a predetermined communication protocol. The communication interface 51 illustrated in FIG. 2 is communicably connected to the PJ communication interface 27 of the projector 20. The communication interface 51 includes, for example, a wired-communication connecting port, a wireless-communication antenna, and an interface circuit. The communication interface 51 receives the comparison image data from the execution unit 45. The communication interface 51 transmits the received comparison image data to the projector 20. The communication interface 51 receives the image correction data from the data processing unit 47. The communication interface 51 transmits the received image correction data to the projector 20. The communication interface 51 may receive various types of data transmitted from the projector 20.

The display 80 displays the display screen based on the screen data transmitted from the display control device 40. The display 80 is connected to the input and output unit 49. The display 80 displays the management screen 100 based on the management screen data transmitted from the display control device 40. The display 80 displays the cursor 200 that moves based on the input operation of the user input to the input device 90. The display 80 receives, via the input and output unit 49, the input data based on the input operation of the user. The display 80 is constituted by a display panel such as a liquid crystal panel or an organic electro-luminescence (EL) panel. The display 80 may receive the input data from the input device 90. The display 80 may be a display device capable of displaying the display screen based on the screen data transmitted from the display control device 40, and a direct-view display device or a projection-type display device may be used.

The input device 90 receives the input operation performed by the user. The input device 90 generates the input data based on the input operation performed by the user. The input device 90 transmits the generated input data to the input and output unit 49. The input device 90 may transmit the generated input data to the display 80. The input device 90 is implemented by one or more devices. The input device 90 illustrated in FIG. 1 is implemented by the keyboard 90a and the mouse 90b. The input device 90 is not limited to the keyboard 90a and the mouse 90b. The input device 90 may be implemented by a liquid crystal pen tablet, a pointer, or the like.

The keyboard 90a receives the input operation performed by the user. The keyboard 90a includes a plurality of keys. The keys are not illustrated. The user operates the management screen 100 by performing the input operation on the keys. The keyboard 90a may receive the input operation combined with the mouse 90b.

The mouse 90b receives the input operation performed by the user. The mouse 90b receives, for example, the cursor operation. When the user performs the cursor operation by using the mouse 90b, the cursor 200 is moved on the display screen. When the user performs the cursor operation, the mouse 90b generates input data including the coordinate information on the cursor 200. When the user performs the input operation such as a click operation on the mouse 90b, the mouse 90b generates input data including the operation signal. The mouse 90b transmits the input data to the input and output unit 49. The mouse 90b may transmit the input data to the display 80. The input device 90 with which the user performs the cursor operation is not limited to the mouse 90b. A pointing device such as a touch pad or a track ball may be used.

In the display system 10 illustrated in FIG. 2, the display 80 and the input device 90 are connected to the display control device 40, but the configuration thereof is not limited thereto. The display 80 may have a touch input function. When the display 80 has the touch input function, the display 80 functions as the input device 90. The display 80 and the input device 90 illustrated in FIG. 2 are separated from the display control device 40, but are not limited thereto. At least one of the display 80 and the input device 90 may be integrated with the display control device 40.

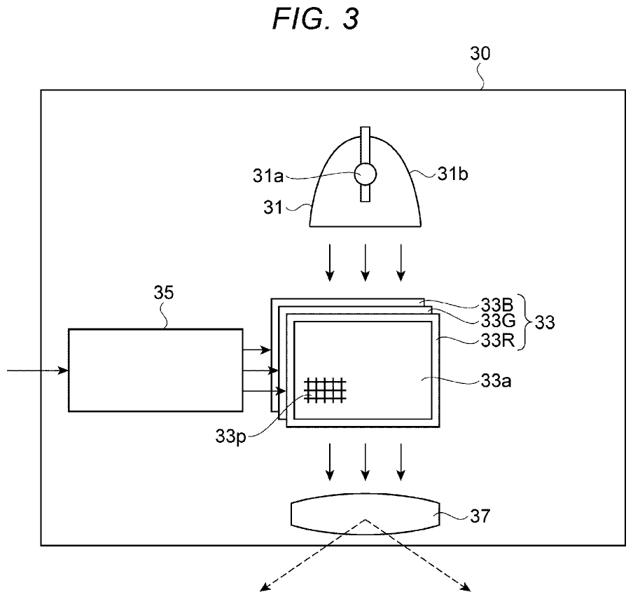

FIG. 3 illustrates a schematic configuration of the projection unit 30. FIG. 3 illustrates an example of the projection unit 30. The projection unit 30 includes a light source 31, three liquid crystal light valves 33, a light valve driver 35, and a projection lens 37.

The light source 31 emits light to the liquid crystal light valve 33. The light source 31 includes a light source unit 31a, a reflector 31b, an integrator optical system (not illustrated), and a color separation optical system (not illustrated). The light source unit 31a emits the light. The light source unit 31a is implemented by a xenon lamp, an ultra-high pressure mercury lamp, a light emitting diode (LED), or a laser light source. The light source 31 emits the light under the control of the PJ control unit 23. The reflector 31b reduces a variation in an emission direction of the light emitted by the light source unit 31a. The integrator optical system reduces a variation in a luminance distribution of the light emitted by the light source 31. The light passing through the reflector 31b enters the color separation optical system. The color separation optical system separates the emitted light into red, green, and blue light components.

The liquid crystal light valve 33 modulates the light emitted by the light source 31. The liquid crystal light valve 33 generates the projection image PG by modulating the light. The liquid crystal light valve 33 is implemented by a liquid crystal panel in which liquid crystal is sealed between a pair of transparent substrates. The liquid crystal light valve 33 includes a rectangular pixel region 33a including a plurality of pixels 33p arranged in a matrix. In the liquid crystal light valve 33, a drive voltage is applied to the liquid crystal for each pixel 33p. The projection unit 30 illustrated in FIG. 3 includes the three liquid crystal light valves 33. The projection unit 30 includes the liquid crystal light valves 33, but is not limited thereto. The projection unit 30 may include one or more digital mirror devices (DMDs).

The three liquid crystal light valves 33 include a red-light liquid crystal light valve 33R, a green-light liquid crystal light valve 33G, and a blue-light liquid crystal light valve 33B. The red light component separated by the color separation optical system is incident on the red-light liquid crystal light valve 33R. The green light component separated by the color separation optical system is incident on the green-light liquid crystal light valve 33G. The blue light component separated by the color separation optical system is incident on the blue-light liquid crystal light valve 33B.

The light valve driver 35 applies the drive voltage to each pixel 33p based on the image data received from the PJ control unit 23. The light valve driver 35 is, for example, a control circuit. The drive voltage is supplied by a drive source (not illustrated). The light valve driver 35 may apply the drive voltage to each pixel 33p based on the image data corrected by the data corrector 25. When the light valve driver 35 applies the drive voltage to each pixel 33p, each pixel 33p is set to a light transmittance based on the image data. The light emitted from the light source 31 is modulated by passing through the pixel region 33a. The three liquid crystal light valves 33 form color component images for each color light.

The projection lens 37 synthesizes the color component images formed by the liquid crystal light valves 33 and projects a synthesized image in an enlarged manner. The projection lens 37 projects the projection image PG onto the projection surface SC. The projection image PG is a multicolor image obtained by synthesizing the color component images.

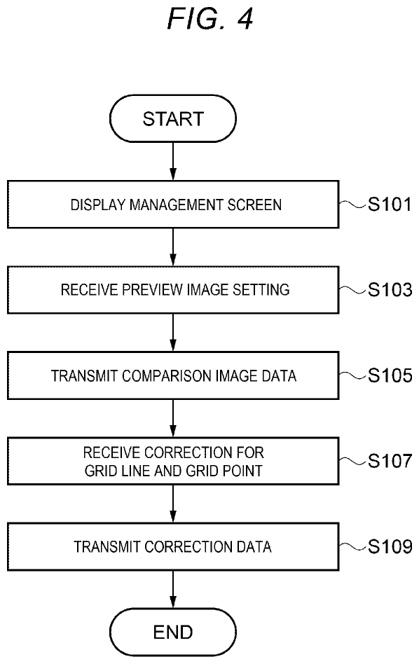

The display control device 40 can allow the user to correct the projection image PG projected onto the projection surface SC by the projector 20. FIG. 4 illustrates a flowchart of the geometric distortion correction. FIG. 4 illustrates a correction procedure of the geometric distortion correction executed in the display control device 40. The user can correct the projection image PG projected onto the projection surface SC by performing the input operation by using the input device 90.

In step S101, the display control device 40 displays the management screen 100 on the display 80. Details of the management screen 100 will be described later. When the user causes the image adjustment program AP to be executed, the display control device 40 displays the management screen 100 on the display 80. The management screen 100 is one of a plurality of display screens displayed when the image adjustment program AP is executed. When the user performs an input operation of designating the display of the management screen 100, the management screen 100 may be displayed on the display 80.

After the management screen 100 is displayed on the display 80, in step S103, the display control device 40 receives a preview image setting performed by the user. The preview image setting is an example of the input data. When the user performs an input operation by using the input device 90, the display control device 40 receives the preview image setting. The preview image setting is the number of grid lines 145 or the number of grid points 147. In the preview image setting, for example, the number of grid points 147 in a vertical direction and the number of grid points 147 in a horizontal direction are set. The vertical direction indicates an up-down direction of the management screen 100. The horizontal direction indicates a left-right direction of the management screen 100.

After receiving the preview image setting, in step S105, the display control device 40 transmits the comparison image data to the projector 20. The display control device 40 generates the comparison image data based on the set preview image setting. The display control device 40 transmits the generated comparison image data to the projector 20. The projector 20 receives the comparison image data, and projects the comparison image CG based on the received comparison image data onto the projection surface SC.

The display control device 40 may transmit the preview image setting to the projector 20. When the display control device 40 transmits the preview image setting to the projector 20, the projector 20 generates the comparison image data. The projector 20 generates the comparison image data by using the preview image setting. The projector 20 projects the comparison image CG based on the generated comparison image data onto the projection surface SC.

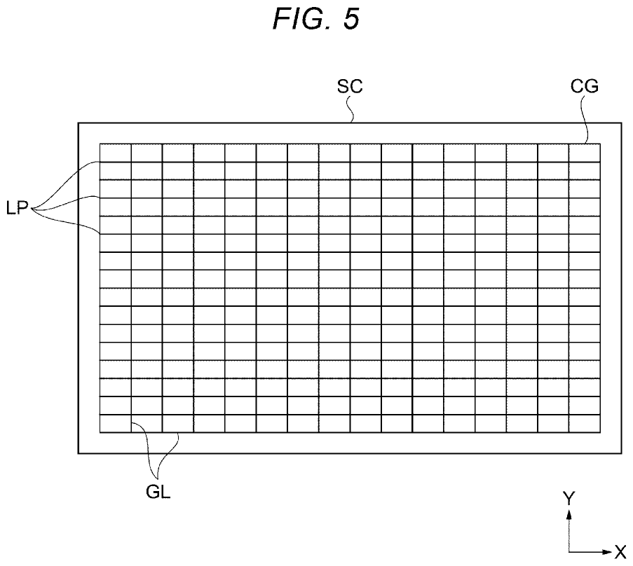

FIG. 5 illustrates an outline of the comparison image CG projected onto the projection surface SC. FIG. 5 illustrates an example of the comparison image CG. The comparison image CG illustrated in FIG. 5 is the projection image PG when 17 grid points 147 in the vertical direction and 17 grid points 147 in the horizontal direction are set in the preview image setting. The comparison image CG is an example of the projection image PG. The horizontal direction of the preview image setting corresponds to the X axis of the projection surface SC. The vertical direction of the preview image setting corresponds to the Y axis of the projection surface SC.

The comparison image CG includes a plurality of comparison grid lines GL and a plurality of comparison grid points LP. The plurality of comparison grid lines GL include the comparison grid lines GL extending along the X axis and the comparison grid lines GL extending along the Y axis. The comparison grid lines GL extending along the X axis are arranged at predetermined intervals along the Y axis. The comparison grid lines GL extending along the Y axis are arranged at predetermined intervals along the X axis. The comparison grid point LP is an intersection of the comparison grid line GL extending along the X axis and the comparison grid line GL extending along the Y axis. The plurality of comparison grid points LP are arranged along the X axis and the Y axis. The user checks the comparison grid lines GL or the comparison grid points LP in the comparison image CG and corrects the projection image PG.

When the projection surface SC is a smooth surface, the plurality of comparison grid lines GL and the plurality of comparison grid points LP are evenly arranged along the X axis and the Y axis as illustrated in FIG. 5. When the projection surface SC has unevenness, for example, the comparison grid line GL and the comparison grid point LP projected at a position of the unevenness are projected at uneven positions different from positions at which the comparison grid line GL and the comparison grid point LP are evenly arranged. The user checks the comparison grid line GL or the comparison grid point LP projected to the uneven position as a correction point.

After projecting the comparison image CG by the projector 20, the display control device 40 receives correction for the grid line 145 or for the grid point 147 in step S107 illustrated in FIG. 4. The display control device 40 displays a preview image 143 corresponding to the preview image setting set in step S103 on the display 80. The preview image 143 is displayed on the management screen 100. The user checks the grid line 145 or the grid point 147 in the preview image 143 corresponding to the correction point as a target point. When the user performs an input operation of moving the target point with the input device 90, the display control device 40 receives the correction for the grid line 145 or for the grid point 147 which is the target point.

After receiving the correction for the grid line 145 or for the grid point 147 which is the target point, in step S109, the display control device 40 transmits the image correction data to the projector 20. The display control device 40 generates the image correction data based on the correction for the grid point 147 or for the grid line 145 which is the target point. The display control device 40 transmits the generated image correction data to the projector 20.

The projector 20 receives the image correction data. The projector 20 corrects the comparison image data by using the image correction data. The projector 20 projects the corrected comparison image data onto the projection surface SC. The user checks the comparison image CG projected based on the comparison image data corrected by the image correction data.

The user checks whether the comparison grid lines GL or the comparison grid points LP included in the comparison image CG projected onto the projection surface SC are arranged at the predetermined intervals along the X axis and the Y axis. When the user determines that the comparison grid lines GL or the comparison grid points LP are arranged at the predetermined intervals, the user ends correction processing. When the user determines that the comparison grid lines GL or the comparison grid points LP are not arranged at the predetermined intervals, the user performs the input operation of moving the grid line 145 or the grid point 147. When the user performs the input operation, the display control device 40 receives the correction for the grid line 145 or for the grid point 147 which is the target point illustrated in step S107. The display control device 40 generates image correction data again based on the received correction for the grid line 145 or for the grid point 147. The display control device 40 transmits the regenerated image correction data to the projector 20. When the user performs the input operation of moving the grid line 145 or the grid point 147, the display control device 40 repeatedly executes step S107 and step S109.

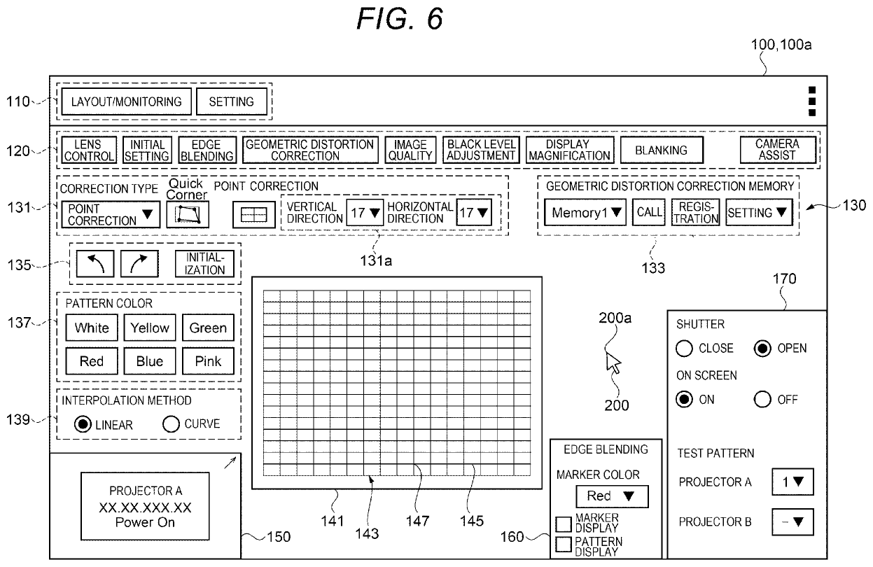

FIG. 6 illustrates a configuration of the management screen 100. The management screen 100 is displayed on the display 80 under the control of the display control device 40. The management screen 100 is displayed on the display 80 when the display control device 40 executes the image adjustment program AP. The management screen 100 illustrated in FIG. 6 is a display screen displayed when the geometric distortion correction is performed. FIG. 6 illustrates a first management screen 100a as an example of the management screen 100.

The first management screen 100a includes a basic setting region 110, a tab region 120, a geometric distortion correction region 130, a sub-window display region 150, an edge blending region 160, and a projector setting region 170. The sub-window display region 150, the edge blending region 160, and the projector setting region 170 are displayed on the geometric distortion correction region 130 in a superimposed manner.

The basic setting region 110 displays a layout/monitoring tab and a setting tab. When the layout/monitoring tab is selected by the input operation of the user, a layout/monitoring region is displayed on the first management screen 100a. When the setting tab is selected by the input operation of the user, a setting region is displayed on the first management screen 100a.

In the layout/monitoring region, a state of the projector 20 connected to the display control device 40 is displayed. The layout/monitoring region is not illustrated. The display control device 40 can be connected to the plurality of projectors 20. When the display control device 40 is connected to the projector 20, the state of the projector 20 is displayed in the layout/monitoring region. The state of the projector 20 includes a power ON/OFF state, a connected state including a network address, an error occurrence state, and the like. When the plurality of projectors 20 are connected to the display control device 40, layouts of the plurality of projectors 20 are displayed in the layout/monitoring region.

The setting region is a region where various settings are performed. When the user selects one of a plurality of tabs displayed in the tab region 120 by the input operation, a region corresponding to the selected tab is displayed on the first management screen 100a. In the first management screen 100a illustrated in FIG. 6, the geometric distortion correction region 130 for setting the geometric distortion correction is shown.

In the tab region 120, a lens control tab, an initial setting tab, an edge blending tab, a geometric distortion correction tab, an image quality tab, a black level adjustment tab, a display magnification tab, a blanking tab, and a camera assist tab are displayed.

When the lens control tab is selected by the input operation of the user, a lens control setting region is displayed on the first management screen 100a. The lens control setting region is not illustrated. In the lens control setting region, various icons for controlling a lens of the projector 20 are displayed. The user adjusts a focus of the lens by performing an input operation on the various icons displayed in the lens control setting region.

When the initial setting tab is selected by the input operation of the user, an initial setting region is displayed on the first management screen 100a. The initial setting region is not illustrated. In the initial setting region, various icons related to a setting of the projector 20 are displayed. The user performs various initial settings by performing an input operation on the various icons displayed in the initial setting region. The initial settings include calibration of the light source 31, a brightness level, initialization of the PJ memory 21, and the like.

When the edge blending tab is selected by the input operation of the user, an edge blending setting region is displayed on the first management screen 100a. The edge blending setting region is not illustrated. The edge blending setting region is displayed, based on the control of the display control device 40, when a single projection image PG is created by the plurality of projectors 20. In the edge blending setting region, various icons for adjusting the projection image PG are displayed. The user adjusts a range where a plurality of the projection images PG are overlapped by performing an input operation on the various icons displayed in the edge blending setting region.

When the image quality tab is selected by the input operation of the user, an image quality setting region is displayed on the first management screen 100a. The image quality setting region is not illustrated. In the image quality setting region, various icons related to an image quality setting of the projection image PG are displayed. The user performs the image quality setting by performing an input operation on the various icons displayed in the image quality setting region. The image quality setting to be set includes color matching, brightness, contrast, frame interpolation, and the like.

When the black level adjustment tab is selected by the input operation of the user, a black level adjustment region is displayed on the first management screen 100a. The black level adjustment region is not illustrated. In the black level adjustment region, various icons related to black level adjustment of the projection images PG projected onto the projection surface SC by the plurality of projectors 20 are displayed. The user performs the black level adjustment by performing an input operation on the various icons displayed in the black level adjustment region. The black level adjustment is adjustment of brightness, a color tone, and the like of a portion where images do not overlap.

When the display magnification tab is selected by the input operation of the user, a display magnification setting region is displayed on the first management screen 100a. The display magnification setting region is not illustrated. In the display magnification setting region, various icons related to a display magnification of the projection image PG are displayed. The user performs a display magnification setting by performing an input operation on the various icons displayed in the display magnification setting region. The display magnification setting is a magnification setting when a part of the projection image PG is enlarged.

When the blanking tab is selected by the input operation of the user, a blanking setting region is displayed on the first management screen 100a. The blanking setting region is not illustrated. In the blanking setting region, various icons related to a setting of the projection image PG are displayed. The user performs a blanking setting by performing an input operation on the various icons displayed in the blanking setting region. The blanking setting is a setting for hiding a specific region of the projection image PG.

When the camera assist tab is selected by the input operation of the user, a camera assist adjustment region is displayed on the first management screen 100a. The camera assist adjustment region is not illustrated. In the camera assist adjustment region, various icons for executing automatic adjustment of the projection image PG by using a camera provided in the projector 20 are displayed. The user executes various types of automatic adjustment on the projection image PG by performing an input operation on the various icons displayed in the camera assist adjustment region. The automatic adjustment for the projection image PG includes screen matching, color calibration, tiling, and the like.

When the geometric distortion correction tab is selected by the input operation of the user, the geometric distortion correction region 130 illustrated in FIG. 6 is displayed on the first management screen 100a. In the geometric distortion correction region 130, various icons related to the geometric distortion correction are displayed. In the geometric distortion correction region 130, a correction setter 131, a file setter 133, an operation instructor 135, a color setter 137, a method setter 139, and a display window 141 are displayed.

The correction setter 131 displays various icons related to a setting of a correction type, a correction type display field for displaying a selected correction type, and a preview image setting field 131a. The correction type to be selected includes curved surface projection correction, corner projection correction, point correction, and curve correction. The preview image setting illustrated in step S103 of FIG. 4 is received in the preview image setting field 131a. The preview image setting field 131a illustrated in FIG. 6 receives the number of grid points 147 in the vertical direction and the number of grid points 147 in the horizontal direction.

The file setter 133 displays various icons for receiving an instruction related to a setting file. The setting file includes a distortion correction setting set in the geometric distortion correction region 130. The user instructs storage of the setting file in the memory 41 by performing an input operation on the various icons displayed in the file setter 133.

The operation instructor 135 displays various icons for controlling the input operation performed by the user in the geometric distortion correction region 130. The user cancels an input operation input immediately before by performing an input operation on the various icons displayed in the operation instructor 135.

The color setter 137 displays a plurality of icons related to designation of a color of the grid line 145 or a color of the grid point 147 displayed in the display window 141. When the user performs an input operation on one icon among the plurality of icons displayed in the color setter 137, the color of the grid line 145 or the color of the grid point 147 displayed in the display window 141 is changed.

The method setter 139 displays selection buttons for selecting an interpolation method between the grid points 147. In the method setter 139 illustrated in FIG. 6, linear interpolation or curve interpolation can be selected. The interpolation method is a position correction method between the adjacent grid points 147.

The display window 141 displays the preview image 143. The preview image 143 corresponds to the comparison image CG projected onto the projection surface SC by the projector 20. The preview image 143 includes the grid line 145 and the grid point 147. The preview image 143 is displayed based on the screen data. The screen data is generated by the screen controller 48 by using default screen data stored in the memory 41. The default screen data includes the predetermined number of grid lines 145 and a predetermined interval between the grid lines 145, or the predetermined number of grid points 147 and a predetermined interval between the grid points 147. The number of grid points 147 included in the default screen data is corrected by a value input into the preview image setting field 131a. The screen data includes the number of grid points 147 corrected based on the value input into the preview image setting field 131a. The display window 141 displays the entire preview image 143.

The screen data generated by the screen controller 48 is transmitted to the display 80 by the input and output unit 49. The display 80 receives the screen data. The display 80 displays the preview image 143 in the display window 141 based on the received screen data. The display control device 40 displays the preview image 143 on the display 80 based on the screen data.

The preview image 143 includes the plurality of grid lines 145 and the plurality of grid points 147. The plurality of grid lines 145 include the grid lines 145 extending along a vertical axis of the display window 141 and the grid lines 145 extending along a horizontal axis of the display window 141. The plurality of grid lines 145 extending along the vertical axis are arranged at the predetermined intervals along the horizontal axis of the display window 141. The plurality of grid lines 145 extending along the horizontal axis are arranged at the predetermined intervals along the vertical axis of the display window 141. The grid point 147 is an intersection of the grid line 145 extending along the vertical axis of the display window 141 and the grid line 145 extending along the horizontal axis of the display window 141. The grid points 147 are arranged at the predetermined intervals along the vertical axis of the display window 141. The number of grid points 147 arranged along the vertical axis of the display window 141 is the same as a value in the vertical direction set in the preview image setting field 131a. The grid points 147 are arranged at the predetermined intervals along the horizontal axis of the display window 141. The number of grid points 147 arranged along the horizontal axis of the display window 141 is the same as a value in the horizontal direction set in the preview image setting field 131a. The grid line 145 and the grid point 147 are examples of the display image displayed on the display screen. The display image corresponds to an example of a control image.

In the sub-window display region 150, a region different from the geometric distortion correction region 130 is displayed. In the sub-window display region 150, for example, the layout/monitoring region or a part of the layout/monitoring region may be displayed. When the user performs the input operation on the sub-window display region 150, the region displayed in the sub-window display region 150 is switched to the geometric distortion correction region 130 and displayed on the first management screen 100a.

In the edge blending region 160, a selection button for receiving an input operation related to the edge blending is displayed. The edge blending region 160 is used when the geometric distortion correction is performed on the projection images PG projected by the plurality of projectors 20 onto the projection surface SC.

In the projector setting region 170, a selection button for receiving an input operation related to the setting of the projector 20 is displayed. The projector setting region 170 is used when the display control device 40 is connected to one or more projectors 20. For example, when selecting the projector 20 that projects the comparison image CG onto the projection surface SC, the user performs the input operation on the selection button displayed in the projector setting region 170.

The management screen 100 displays the cursor 200. The cursor 200 is moved by the cursor operation of the user. When the user performs the cursor operation by using the input device 90 such as the mouse 90b, the cursor 200 is moved on the management screen 100. The cursor 200 is movable to any grid line 145 or any grid point 147. The user uses the cursor 200 when performing the input operation on any grid line 145 or any grid point 147. The cursor 200 is operated when the user performs the cursor operation by using the input device 90.

The cursor 200 illustrated in FIG. 6 has an arrow shape. A shape of the cursor 200 is not limited to the arrow shape. The shape of the cursor 200 can be appropriately selected from a cross shape, a circular shape, and the like. The cursor tip 200a of the arrow-shaped cursor 200 indicates a position instructed by the user. The instruction position is appropriately changed according to the shape of the cursor 200. When the shape of the cursor 200 is, for example, a cross shape, a center position of the cursor 200 is the position instructed by the user.

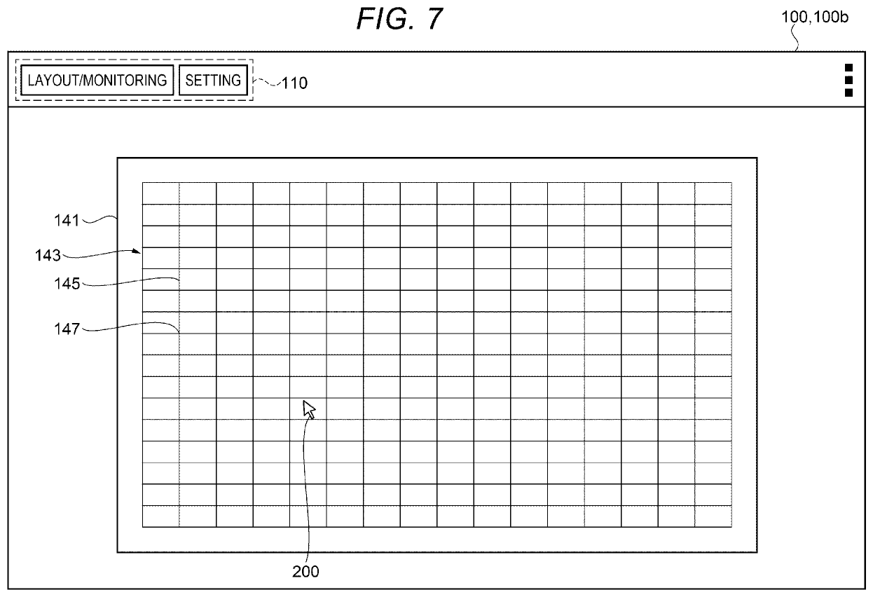

FIG. 7 illustrates a configuration of the management screen 100. FIG. 7 illustrates a second management screen 100b as an example of the management screen 100. The second management screen 100b is displayed on the display 80 under the control of the display control device 40. The second management screen 100b is displayed on the display 80 when the display control device 40 executes the image adjustment program AP. The second management screen 100b is a screen displayed when the geometric distortion correction is performed.

The second management screen 100b displays the display window 141 in an enlarged manner. When the user performs a predetermined input operation, the first management screen 100a is switched to the second management screen 100b. The user can appropriately switch between the first management screen 100a and the second management screen 100b. The display window 141 is displayed on the second management screen 100b in an enlarged manner, and thus the user easily recognizes the preview image 143 visually. The second management screen 100b displays the basic setting region 110 and the display window 141, but is not limited thereto. The second management screen 100b may display the tab region 120. The second management screen 100b may display a part of configurations such as the correction setter 131 displayed in the geometric distortion correction region 130.

### First Embodiment

A first embodiment discloses display control of changing a display mode of the grid point 147. The first embodiment discloses a change in the display mode of the grid point 147 when the cursor tip 200a of the cursor 200 is located in a cursor detection region 210 of the grid point 147. When the cursor tip 200a is located in the cursor detection region 210 of the grid point 147, the screen controller 48 performs the display control of changing the display mode of the grid point 147.

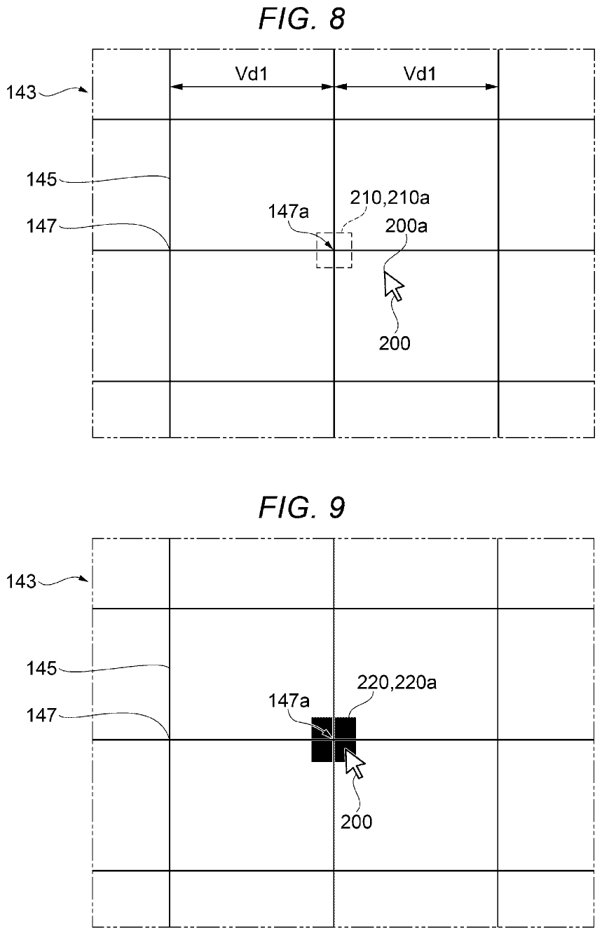

FIG. 8 illustrates a schematic configuration when a part of the preview image 143 is displayed in an enlarged manner. FIG. 8 illustrates a part of the preview image 143 illustrated in FIG. 6 in an enlarged manner. FIG. 8 illustrates the plurality of grid lines 145, the plurality of grid points 147, and the cursor 200. The grid lines 145 extending along a vertical axis are arranged at a first inter-vertical-line distance Vd1. FIG. 8 illustrates a first grid point 147a that is one of the plurality of grid points 147.

FIG. 8 virtually illustrates a first cursor detection region 210a that is the cursor detection region 210 of the first grid point 147a. The cursor detection region 210 is a region where a grid point operation for the corresponding grid point 147 can be received. The cursor detection region 210 includes a grid point display position where the corresponding grid point 147 is displayed. The grid point display position is an example of an image display position. When the cursor tip 200a of the cursor 200 is located in the cursor detection region 210, the user can perform the grid point operation on the grid point 147. The grid point operation includes a selection operation, a selection release operation, a lock operation, a lock release operation, a movement operation, and the like for the grid point 147. The grid point 147 is an example of a display image. The cursor detection region 210 corresponding to the grid point 147 is an example of a display image region. The first cursor detection region 210a is a region where the grid point operation for the first grid point 147a can be received. The first cursor detection region 210a includes a grid point display position of the first grid point 147a. The first grid point 147a corresponds to an example of a target image. The grid point display position of the first grid point 147a corresponds to an example of a display position where the target image is displayed.

FIG. 8 illustrates a state where the cursor tip 200a is located at a position different from the first cursor detection region 210a. A display position of the cursor 200 on the preview image 143 is determined by the execution unit 45. When the cursor tip 200a is located outside the first cursor detection region 210a, a display mode of the first grid point 147a is not changed. The display mode of the first grid point 147a is the same as those of the other grid points 147.

FIG. 9 illustrates a schematic configuration when a part of the preview image 143 is displayed in an enlarged manner. FIG. 9 illustrates a state where the cursor tip 200a is located in the first cursor detection region 210a. FIG. 9 illustrates a state where a first mark image 220a is displayed at the first grid point 147a. The first mark image 220a is an example of the mark image 220. The first mark image 220a is displayed at a position corresponding to the first cursor detection region 210a. The first cursor detection region 210a is not illustrated.

When the cursor tip 200a is located in the first cursor detection region 210a, the screen controller 48 displays the first mark image 220a on the first grid point 147a in a superimposed manner. The screen controller 48 performs display control of displaying the first mark image 220a on the first grid point 147a. The screen controller 48 changes the display mode of the first grid point 147a by displaying the first mark image 220a on the first grid point 147a. The first cursor detection region 210a corresponds to an example of a control region. The mark image 220 including the first mark image 220a corresponds to an example of an index image.

The first mark image 220a illustrated in FIG. 9 is illustrated in a square shape, but is not limited thereto. The mark image 220 including the first mark image 220a may be illustrated in a circular shape, an elliptical shape, a rhombus shape, or the like. The mark image 220 is not limited to black. The mark image 220 may be displayed in red, blue, green, yellow, or the like. The mark image 220 may be displayed in a form that changes over time, such as blinking. The mark image 220 may be configured such that the first grid point 147a is displayed in a display mode distinguishable from the other grid points 147.

The screen controller 48 displays the first mark image 220a on the first grid point 147a, thereby differentiating the display mode of the first grid point 147a from display modes of the other grid points 147. Since the first mark image 220a is displayed, the user easily identifies the first grid point 147a. In addition, the user can recognize that the grid point operation can be executed on the first grid point 147a.

FIG. 10 illustrates a schematic configuration when a part of the preview image 143 is displayed in an enlarged manner. FIG. 10 illustrates a state where the movement operation is performed on the first grid point 147a. The movement operation is an example of the grid point operation. The first grid point 147a illustrated in FIG. 10 is moved to a movement position different from the grid point display position of the first grid point 147a illustrated in FIG. 9.

The cursor tip 200a of the cursor 200 is located in the first cursor detection region 210a of the first grid point 147a. The first mark image 220a is displayed on the first grid point 147a in a superimposed manner. In FIG. 10, the first mark image 220a is displayed on the first grid point 147a located at the movement position, and is not limited thereto. When the user performs the movement operation on the first grid point 147a, the first mark image 220a may be continuously displayed. When the user performs the movement operation on the first grid point 147a, the first mark image 220a may be deleted. A timing of deleting the mark image 220 is appropriately set.

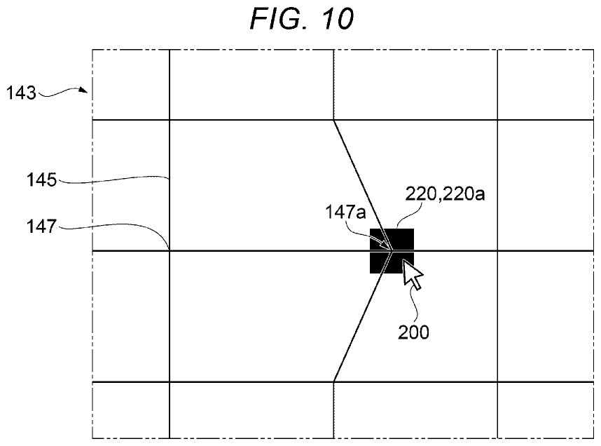

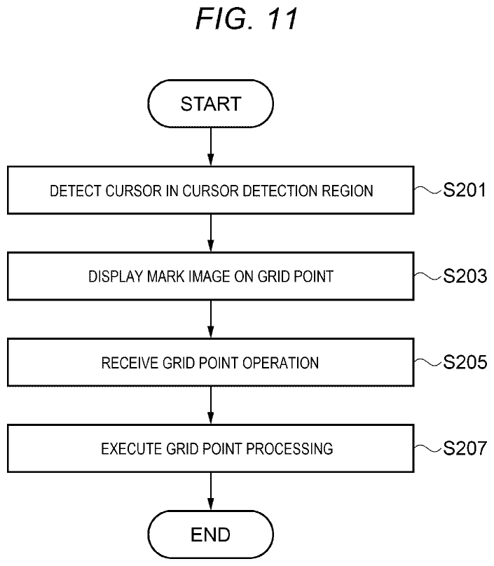

FIG. 11 illustrates a flowchart of the display control. FIG. 11 illustrates a display control method when the user performs the grid point operation on the grid point 147. The display control method illustrated in FIG. 11 is executed when the control unit 43 operates the image adjustment program AP.

In step S201, the control unit 43 detects the cursor 200 in the cursor detection region 210. The execution unit 45, which is a functional unit of the control unit 43, acquires coordinate information on the cursor 200 included in input data. When the user performs a cursor operation by using the mouse 90b, the mouse 90b generates the input data. The input data includes the coordinate information on the cursor 200. The coordinate information on the cursor 200 is coordinate information on the cursor tip 200a. The mouse 90b transmits the input data to the input and output unit 49. The input and output unit 49 receives the input data. By receiving the input data, the input and output unit 49 receives the cursor operation performed by the user. The input and output unit 49 transmits the input data to the execution unit 45.

The execution unit 45 receives the input data. The execution unit 45 acquires the coordinate information on the cursor 200 included in the input data. The execution unit 45 detects the display position of the cursor 200 on the preview image 143 by using the coordinate information. The display position of the cursor 200 includes a position of the cursor tip 200a. The execution unit 45 transmits the detected display position of the cursor 200 to the screen controller 48.

The screen controller 48 receives the display position of the cursor 200 on the preview image 143. The screen controller 48 determines whether the cursor tip 200a is located in the first cursor detection region 210a of the first grid point 147a. The first grid point 147a is one of the plurality of grid points 147. When the cursor tip 200a is not located in the first cursor detection region 210a, the control unit 43 does not execute the display control.

When the cursor tip 200a is located in the first cursor detection region 210a, in step S203, the control unit 43 displays the first mark image 220a on the first grid point 147a. The screen controller 48 determines that the cursor tip 200a is located in the first cursor detection region 210a of the first grid point 147a. The screen controller 48 generates screen data for displaying the first mark image 220a on the first grid point 147a. The screen controller 48 transmits the generated screen data to the display 80 via the input and output unit 49. The screen controller 48 displays the first mark image 220a on the first grid point 147a in a superimposed manner. The display 80 displays the preview image 143 in which the first mark image 220a is displayed on the first grid point 147a in a superimposed manner.

The screen controller 48 performs the display control of displaying the first mark image 220a on the first grid point 147a in a superimposed manner. The screen controller 48 changes the display mode of the first grid point 147a by displaying the first mark image 220a on the first grid point 147a in a superimposed manner.

After the first mark image 220a is displayed, the control unit 43 receives the grid point operation in step S205. When the user performs an input operation in a state where the first mark image 220a is displayed, the input and output unit 49 receives the input data. The input data includes an operation signal corresponding to the grid point operation. The input and output unit 49 receives the grid point operation by receiving the input data. The input and output unit 49 transmits the received input data to the execution unit 45.

The execution unit 45 receives the input data. The execution unit 45 acquires the operation signal included in the input data. The execution unit 45 determines, based on the operation signal, an input instruction corresponding to the input operation performed by the user. The execution unit 45 transmits the determined input instruction to the screen controller 48.

After receiving the grid point operation, the control unit 43 executes grid point processing in step S207. The execution unit 45 executes the grid point processing corresponding to the input instruction. The execution unit 45 executes the grid point processing on the first grid point 147a. When the input instruction is, for example, a selection instruction, the execution unit 45 shifts the first grid point 147a from a grid point unselected state to a grid point selected state. When the input instruction is a movement instruction, the execution unit 45 moves the first grid point 147a from the grid point display position to the movement position. When moving the first grid point 147a to the movement position, the execution unit 45 transmits the movement position to the screen controller 48. The screen controller 48 receives the movement position. The screen controller 48 generates the screen data by using the movement position. The screen controller 48 transmits the generated screen data to the display 80 via the input and output unit 49. The screen controller 48 displays the first management screen 100a based on the screen data on the display 80. The first management screen 100a displays the first grid point 147a moved to the movement position.

The display control method includes: changing the display mode of the first grid point 147a when the cursor 200 is located in the first cursor detection region 210a of the first grid point 147a that includes the grid point display position where the first grid point 147a which is one of the plurality of grid points 147 for correcting the projection image PG projected by the projector 20 is displayed.

The user can check whether the first grid point 147a is a desired grid point 147 by visually recognizing the first grid point 147a whose display mode is changed. By checking that the first grid point 147a is the desired grid point 147, the user can check that the cursor 200 is located at a desired position.

Changing the display mode of the first grid point 147a includes displaying the first mark image 220a on the first grid point 147a in a superimposed manner.

By displaying the first mark image 220a on the first grid point 147a in a superimposed manner, the user can visually recognize a position of the first grid point 147a easily.

The display control device 40 includes the control unit 43 and the input and output unit 49. The control unit 43 displays the cursor 200 and the plurality of grid points 147 for correcting the projection image PG projected by the projector 20, and changes the display mode of the first grid point 147a when the cursor 200 is located in the first cursor detection region 210a of the first grid point 147a that includes the grid point display position where the first grid point 147a which is one of the plurality of grid points 147 is displayed. The input and output unit 49 receives the cursor operation for the cursor 200.

The user of the display control device 40 can check whether the first grid point 147a is the desired grid point 147 by visually recognizing the first grid point 147a whose display mode is changed. By checking that the first grid point 147a is the desired grid point 147, the user can check that the cursor 200 is located at the desired position.

The image adjustment program AP causes the control unit 43 to display the cursor 200 and the plurality of grid points 147 for correcting the projection image PG projected by the projector 20, receive the cursor operation for the cursor 200, and change the display mode of the first grid point 147a when the cursor 200 is located in the first cursor detection region 210a of the first grid point 147a that includes the grid point display position where the first grid point 147a which is one of the plurality of grid points 147 is displayed.

The user causing the image adjustment program AP to be executed can check whether the first grid point 147a is the desired grid point 147 by visually recognizing the first grid point 147a whose display mode is changed. By checking that the first grid point 147a is the desired grid point 147, the user can check that the cursor 200 is located at the desired position.

### Second Embodiment

A second embodiment discloses display control of changing a display mode of the grid line 145. The second embodiment discloses the display control of the display mode of the grid line 145 when the cursor tip 200a of the cursor 200 is located in the cursor detection region 210 of the grid line 145. When the cursor tip 200a is located in the cursor detection region 210 of the grid line 145, the screen controller 48 performs the display control of changing the display mode of the grid line 145.

FIG. 12 illustrates a schematic configuration when a part of the preview image 143 is displayed in an enlarged manner. FIG. 12 illustrates a part of the preview image 143 illustrated in FIG. 6 in an enlarged manner. FIG. 12 illustrates a plurality of grid lines 145, a plurality of grid points 147, and the cursor 200. FIG. 12 illustrates a first grid line 145a that is one of the plurality of grid lines 145. The first grid line 145a indicates a part of the grid line 145 passing through a second grid point 147b and a third grid point 147c.

FIG. 12 virtually illustrates a second cursor detection region 210b that is the cursor detection region 210 of the first grid line 145a. The cursor detection region 210 is a region where a grid line operation for the corresponding grid line 145 can be received. The cursor detection region 210 includes a grid line display position where the corresponding grid line 145 is displayed. The grid line display position is an example of an image display position. When the cursor tip 200a of the cursor 200 is located in the cursor detection region 210, a user can perform the grid line operation on the grid line 145. The grid line operation includes a selection operation, a selection release operation, a lock operation, a lock release operation, a movement operation, and the like for the grid line 145. The grid line 145 is an example of a display image. The cursor detection region 210 corresponding to the grid line 145 is an example of a display image region. The second cursor detection region 210b is a region where a grid line operation for the first grid line 145a can be received. The second cursor detection region 210b includes a grid line display position of the first grid line 145a. The first grid line 145a corresponds to an example of a target image. The grid line display position of the first grid line 145a corresponds to an example of a display position where the target image is displayed.

FIG. 12 illustrates a state where the cursor tip 200a is located at a position different from the second cursor detection region 210b. A display position of the cursor 200 on the preview image 143 is determined by the execution unit 45. When the cursor tip 200a is located outside the second cursor detection region 210b, a display mode of the first grid line 145a is not changed. The first grid line 145a is displayed in first display D1. The display mode of the first grid line 145a is the same as those of the other grid lines 145.

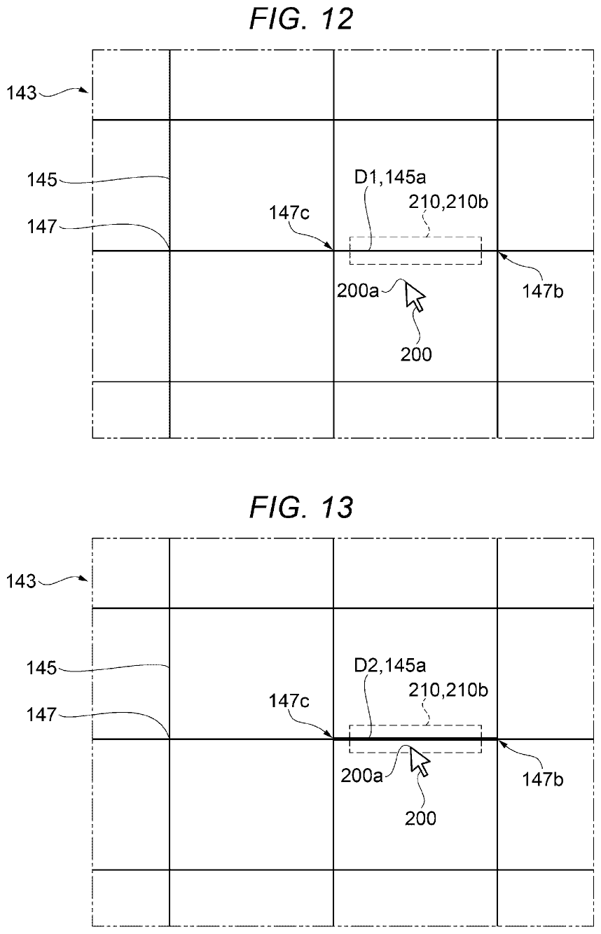

FIG. 13 illustrates a schematic configuration when a part of the preview image 143 is displayed in an enlarged manner. FIG. 13 illustrates a state where the cursor tip 200a is located in the second cursor detection region 210b. In FIG. 13, the first grid line 145a is displayed in second display D2. The second display D2 is a display mode different from the first display D1.

When the cursor tip 200a is located in the second cursor detection region 210b, the screen controller 48 changes the display mode of the first grid line 145a from the first display D1 to the second display D2. The screen controller 48 performs display control of changing the display mode of the first grid line 145a. The screen controller 48 changes the display mode of the first grid line 145a by changing from the first display D1 to the second display D2. The second cursor detection region 210b corresponds to an example of a control region.

The first grid line 145a in the second display D2 illustrated in FIG. 13 has a line width larger than that of the first grid line 145a in the first display D1 illustrated in FIG. 12. The screen controller 48 makes the first display D1 different from the second display D2 by making the line width of the grid line 145 different from each other. A change in the display mode is not limited to the change in the line width. The screen controller 48 may make the first display D1 different from the second display D2 by making a color, a shape, and the like of the grid line 145 different from each other. The screen controller 48 may change the display mode by displaying the mark image 220 on the grid line 145 in a superimposed manner.

The screen controller 48 changes the first grid line 145a from the first display D1 to the second display D2, thereby making the display mode of the first grid line 145a different from display modes of the other grid lines 145. The user easily identify the first grid line 145a. In addition, the user can recognize that the grid line operation can be executed on the first grid line 145a.

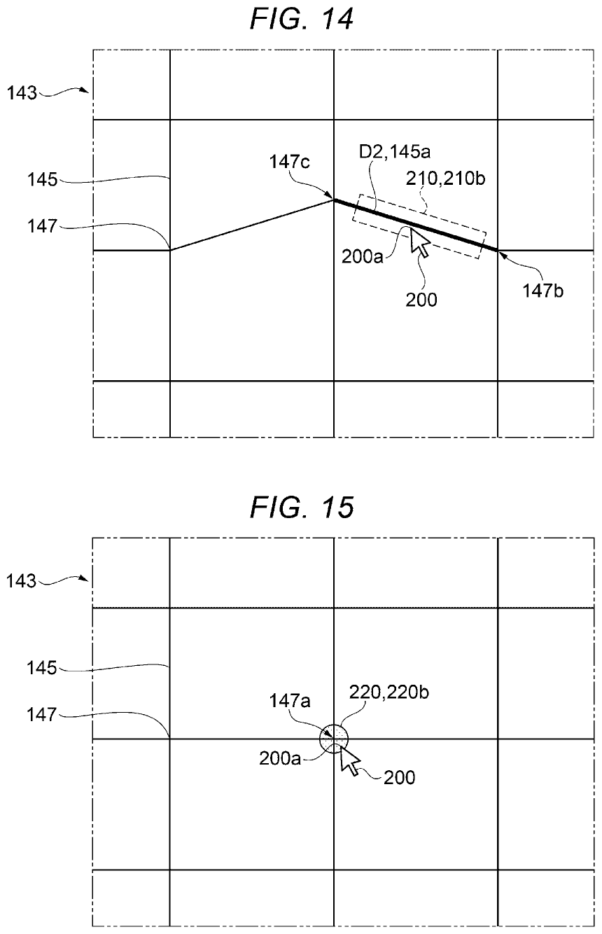

FIG. 14 illustrates a schematic configuration when a part of the preview image 143 is displayed in an enlarged manner. FIG. 14 illustrates a state where a rotational movement operation is performed on the first grid line 145a. The rotational movement operation is an example of the grid line operation. The first grid line 145a illustrated in FIG. 14 is rotationally moved to a movement position different from the grid line display position of the first grid line 145a illustrated in FIG. 13.

The first grid line 145a is rotationally moved around the second grid point 147b. When the user performs a predetermined input operation on the first grid line 145a, the first grid line 145a is rotationally moved. When the first grid line 145a is rotationally moved, the third grid point 147c, which is one end of the first grid line 145a, is moved. When the third grid point 147c is moved, the grid line 145 adjacent to the first grid line 145a is rotationally moved. The grid line 145 adjacent to the first grid line 145a is the grid line 145 having the third grid point 147c as one end.

The cursor tip 200a of the cursor 200 is located in the second cursor detection region 210b of the first grid line 145a. The first grid line 145a is displayed in the second display D2. In FIG. 14, the first grid line 145a located at the movement position is displayed in the second display D2, but is not limited thereto. When the user performs the rotational movement operation on the first grid line 145a, the first grid line 145a may be continuously displayed in the second display D2. When the user performs the rotational movement operation on the first grid line 145a, the first grid line 145a may be displayed in the first display D1. A timing of changing from the second display D2 to the first display D1 is appropriately set.

The grid line 145 is controlled by the same display control method as that for the grid point 147. The control unit 43 controls the display control for the grid line 145 and grid line processing in the flowchart illustrated in FIG. 11.

The display control method includes changing the display mode of the first grid line 145a when the cursor 200 is located in the second cursor detection region 210b of the first grid line 145a that includes the grid line display position where the first grid line 145a which is one of the plurality of grid lines 145 for correcting the projection image PG projected by the projector 20 is displayed.

The user can check whether the grid line 145a is the grid line 145 that the user desires to perform the grid line operation by visually recognizing the first grid line 145a whose display mode is changed. By checking that the first grid line 145a is the desired grid line 145, the user can check that the cursor 200 is located at a desired position.

### Third Embodiment

A third embodiment discloses display control of changing a display mode of the grid point 147. The third embodiment discloses the display control of the display mode of the grid point 147 when a predetermined grid point operation is performed on the grid point 147 whose display mode is changed. In the third embodiment, when the predetermined grid point operation is received, the control unit 43 performs the display control of changing the display mode of the grid point 147.

FIG. 15 illustrates a schematic configuration when a part of the preview image 143 is displayed in an enlarged manner. FIG. 15 illustrates a state where the cursor tip 200a is located in the first cursor detection region 210a. FIG. 15 illustrates a state where a second mark image 220b is displayed on the first grid point 147a. The second mark image 220b is an example of the mark image 220. The second mark image 220b is displayed at a position corresponding to the first cursor detection region 210a. The first cursor detection region 210a is not illustrated.

When the cursor tip 200a is located in the first cursor detection region 210a, the screen controller 48 displays the second mark image 220b on the first grid point 147a in a superimposed manner. The screen controller 48 performs the display control of displaying the second mark image 220b on the first grid point 147a. The screen controller 48 changes a display mode of the first grid point 147a by displaying the second mark image 220b on the first grid point 147a. The second mark image 220b corresponds to an example of an index image.

The second mark image 220b illustrated in FIG. 15 is formed in a circular shape. The screen controller 48 appropriately controls a shape, a color, and the like of the mark image 220. The second mark image 220b is a transparent image. The transparent image is an image having a transmittance larger than 0%. The transparent image is an image through which the grid point 147 on which the transparent image displayed in a superimposed manner is visually recognized. Since the second mark image 220b is the transparent image, the user can visually recognize the first grid point 147a on which the second mark image 220b is displayed in a superimposed manner.

The screen controller 48 displays the second mark image 220b on the first grid point 147a, thereby differentiating the display mode of the first grid point 147a from display modes of the other grid points 147. Since the second mark image 220b is displayed, the user easily identifies the first grid point 147a. In addition, the user can recognize that the grid point operation can be executed on the first grid point 147a.

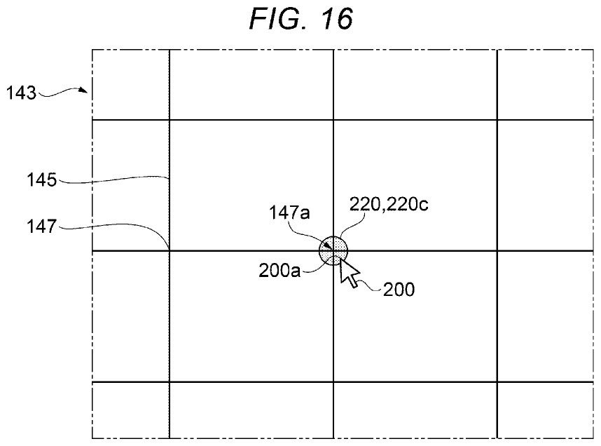

FIG. 16 illustrates a schematic configuration when a part of the preview image 143 is displayed in an enlarged manner. FIG. 16 illustrates a state where a state change operation is performed on the first grid point 147a. The state change operation is an example of the grid point operation. The state change operation is an operation of changing a state of the grid point 147. The state change operation includes a grid point selection operation, a grid point lock operation, and the like. When the second mark image 220b is displayed on the first grid point 147a, the user can perform the state change operation on the first grid point 147a. When the user performs the state change operation, the second mark image 220b is changed to a third mark image 220c illustrated in FIG. 16. The third mark image 220c corresponds to an example of the index image. The state change operation corresponds to an example of an image operation.

When the state change operation is performed on the first grid point 147a on which the second mark image 220b is displayed, the screen controller 48 performs display control of changing the second mark image 220b to the third mark image 220c. The screen controller 48 changes the second mark image 220b to the third mark image 220c, thereby changing the display mode of the first grid point 147a.

The third mark image 220c is an image different from the second mark image 220b. The screen controller 48 changes an image shape, a color, a color shade, the transmittance, and the like, thereby making the third mark image 220c different from the and the second mark image 220b. The screen controller 48 switches from the second mark image 220b to the third mark image 220c. By visually recognizing the third mark image 220c, the user can check that the state change operation for the first grid point 147a is received.

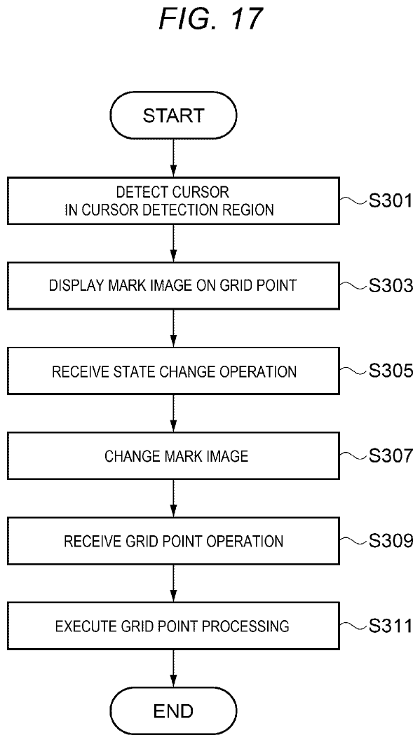

FIG. 17 illustrates a flowchart of the display control. FIG. 17 illustrates a display control method when the user performs the grid point operation on the grid point 147. The display control method illustrated in FIG. 17 is executed when the control unit 43 operates the image adjustment program AP.

In step S301, the control unit 43 detects the cursor 200 in the cursor detection region 210. The execution unit 45, which is a functional unit of the control unit 43, acquires coordinate information on the cursor 200 included in input data. When the user performs a cursor operation by using the mouse 90b, the mouse 90b generates the input data. The input data includes the coordinate information on the cursor 200. The coordinate information on the cursor 200 is coordinate information on the cursor tip 200a. The mouse 90b transmits the input data to the input and output unit 49. The input and output unit 49 receives the input data. By receiving the input data, the input and output unit 49 receives the cursor operation performed by the user. The input and output unit 49 transmits the input data to the execution unit 45.

The execution unit 45 receives the input data. The execution unit 45 acquires the coordinate information on the cursor 200 included in the input data. The execution unit 45 detects a display position of the cursor 200 on the preview image 143 by using the coordinate information. The display position of the cursor 200 includes a position of the cursor tip 200a. The execution unit 45 transmits the detected display position of the cursor 200 to the screen controller 48.

The screen controller 48 receives the display position of the cursor 200 on the preview image 143. The screen controller 48 determines whether the cursor tip 200a is located in the first cursor detection region 210a of the first grid point 147a. The first grid point 147a is one of the plurality of grid points 147. When the cursor tip 200a is not located in the first cursor detection region 210a, the control unit 43 does not execute the display control.

When the cursor tip 200a is located in the first cursor detection region 210a, in step S303, the control unit 43 displays the second mark image 220b on the first grid point 147a. The screen controller 48 determines that the cursor tip 200a is located in the first cursor detection region 210a of the first grid point 147a. The screen controller 48 generates screen data for displaying the second mark image 220b on the first grid point 147a. The screen controller 48 transmits the generated screen data to the display 80 via the input and output unit 49. The screen controller 48 displays the second mark image 220b on the first grid point 147a in a superimposed manner. The display 80 displays the preview image 143 in which the second mark image 220b is displayed on the first grid point 147a in a superimposed manner.

The screen controller 48 performs the display control of displaying the second mark image 220b on the first grid point 147a in a superimposed manner. The screen controller 48 changes the display mode of the first grid point 147a by displaying the second mark image 220b on the first grid point 147a in a superimposed manner.

After the second mark image 220b is displayed, in step S305, the control unit 43 receives the state change operation. When the user performs an input operation in a state where the second mark image 220b is displayed, the input and output unit 49 receives the input data. The input data includes an operation signal corresponding to the state change operation. The input and output unit 49 receives the state change operation by receiving the input data. The input and output unit 49 transmits the received input data to the execution unit 45.

The execution unit 45 receives the input data. The execution unit 45 acquires the operation signal included in the input data. The execution unit 45 determines, based on the operation signal, an input instruction corresponding to the state change operation performed by the user. When the state change operation is the grid point selection operation, the execution unit 45 determines that the input instruction is a selection instruction. When the state change operation is the grid point lock operation, the execution unit 45 determines that the input instruction is a lock instruction. The execution unit 45 transmits the determined input instruction to the screen controller 48.

When determining the input instruction, the execution unit 45 shifts a state of the first grid point 147a. The execution unit 45 shifts the state of the first grid point 147a to a state corresponding to the input instruction. The execution unit 45 shifts the first grid point 147a from a before-operation state to an after-operation state. The after-operation state is a state different from the before-operation state. When the execution unit 45 determines that the input instruction is, for example, the selection instruction, the execution unit 45 shifts the first grid point 147a from a grid point unselected state to a grid point selected state. The grid point unselected state is an example of the before-operation state. The grid point selected state is an example of the after-operation state. The execution unit 45 stores state information indicating that the first grid point 147a is in the grid point selected state in the memory 41. The first grid point 147a can receive a grid point operation corresponding to the grid point selected state. The grid point operation corresponding to the grid point selected state includes a grid point movement operation, a grid point selection release operation, the grid point lock operation, and the like. The grid point operation corresponding to the grid point selected state is a part of the grid point operation. The before-operation state corresponds to an example of a first state. The after-operation state corresponds to an example of a second state.

After receiving the state change operation, in step S307, the control unit 43 changes the mark image 220. The screen controller 48 receives the input instruction. The screen controller 48 performs, based on the received input instruction, the display control of changing the second mark image 220b to the third mark image 220c. The third mark image 220c corresponds to the input instruction. A correlation between the mark image 220 and the input instruction is set in advance. When it is determined that the input instruction is the selection instruction, the screen controller 48 performs the display control of changing the second mark image 220b to the third mark image 220c illustrated in FIG. 16. The screen controller 48 generates screen data for displaying the third mark image 220c. The screen controller 48 transmits the generated screen data to the display 80 via the input and output unit 49. The screen controller 48 displays, on the display 80, the preview image 143 in which the third mark image 220c is displayed on the first grid point 147a in a superimposed manner.

After changing the mark image 220, in step S309, the control unit 43 receives the grid point operation. When the user performs an input operation on the first grid point 147a in a state where the third mark image 220c is displayed, the input and output unit 49 receives input data. The input data includes an operation signal corresponding to the grid point operation. The input and output unit 49 receives the grid point operation by receiving the input data. The grid point operation received by the input and output unit 49 is the grid point operation corresponding to the grid point selected state. The input and output unit 49 transmits the received input data to the execution unit 45.

The execution unit 45 receives the input data. The execution unit 45 acquires the operation signal included in the input data. The execution unit 45 determines, based on the operation signal, an input instruction corresponding to the grid point operation performed by the user. The determined input instruction includes a movement instruction, a selection release instruction, the lock instruction, and the like. The execution unit 45 transmits the determined input instruction to the screen controller 48.

After receiving the grid point operation, in step S311, the control unit 43 executes grid point processing. The execution unit 45 executes the grid point processing corresponding to the input instruction. The execution unit 45 executes the grid point processing on the first grid point 147a. When the input instruction is, for example, the movement instruction, the execution unit 45 moves the first grid point 147a from a grid point display position to a movement position. When moving the first grid point 147a to the movement position, the execution unit 45 transmits the movement position to the screen controller 48. The screen controller 48 receives the movement position. The screen controller 48 generates screen data by using the movement position. The screen controller 48 transmits the generated screen data to the display 80 via the input and output unit 49. The screen controller 48 displays the first management screen 100a based on the screen data on the display 80. The first management screen 100a displays the first grid point 147a moved to the movement position.

The display control method further includes shifting the first grid point 147a from the before-operation state to the after-operation state different from the before-operation state when the cursor 200 is located in the cursor detection region 210 and the state change operation is performed on the first grid point 147a.

The display control device 40 can perform the control corresponding to the state of the grid point 147.

The display control method further includes changing the display mode to a display mode indicating that the first grid point 147a is in the after-operation state when the first grid point 147a is shifted to the after-operation state.

The user can check that the state change operation is performed on the first grid point 147a.

The third embodiment discloses display control of the grid point 147, but is not limited thereto. When performing display control on the grid line 145, the control unit 43 can perform display control similar to the display control of the grid point 147 on the grid line 145.

### Fourth Embodiment

A fourth embodiment discloses a display mode different from those in the first embodiment and the third embodiment. The fourth embodiment discloses the mark image 220 different from the first mark image 220a, the second mark image 220b, and the third mark image 220c.

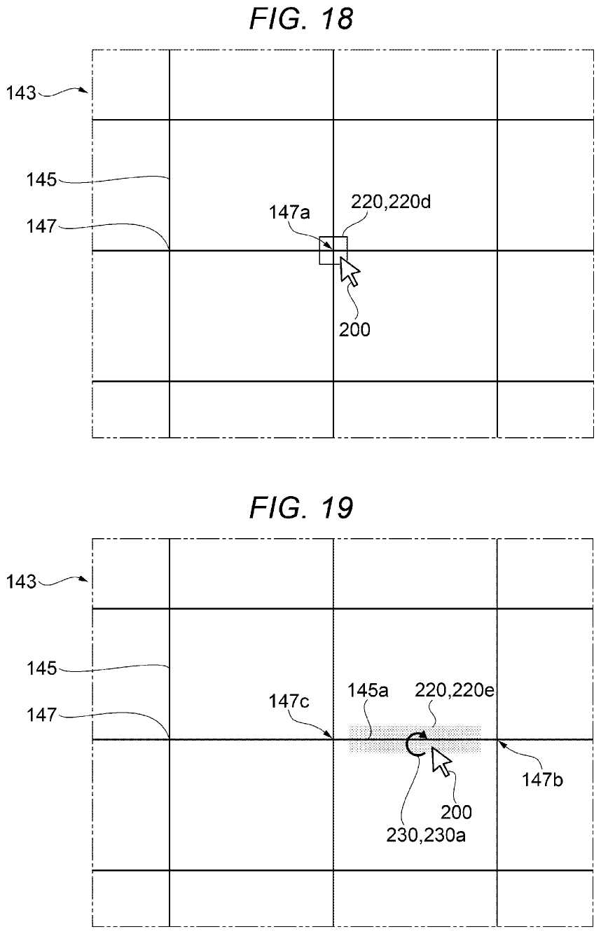

FIG. 18 illustrates a schematic configuration when a part of the preview image 143 is displayed in an enlarged manner. FIG. 18 illustrates a state where the cursor tip 200a is located in the first cursor detection region 210a. FIG. 18 illustrates a state where a fourth mark image 220d is displayed on the first grid point 147a. The fourth mark image 220d is an example of the mark image 220. The fourth mark image 220d is displayed at a position corresponding to the first cursor detection region 210a. The first cursor detection region 210a is not illustrated.

When the cursor tip 200a is located in the first cursor detection region 210a, the screen controller 48 displays the fourth mark image 220d on the first grid point 147a in a superimposed manner. The screen controller 48 performs display control of displaying the fourth mark image 220d on the first grid point 147a. The screen controller 48 changes a display mode of the first grid point 147a by displaying the fourth mark image 220d on the first grid point 147a.

The fourth mark image 220d illustrated in FIG. 18 is illustrated in a square shape. The fourth mark image 220d is a transparent image that allows a user to visually recognize the first grid point 147a. The fourth mark image 220d is a transparent image having an outline and a transmittance of 100%. Since the fourth mark image 220d is the transparent image, the user can easily check a position of the first grid point 147a.

The mark image 220 may be the transparent image through which the first grid point 147a is visually recognized.

Since the user can visually recognize the mark image 220 and the first grid point 147a, the user can easily grasp whether the first grid point 147a is the desired grid point 147.

The screen controller 48 may change any one of brightness, a color degree, and the transmittance of the fourth mark image 220d over time. By changing any one of the brightness, the color degree, and the transmittance over time, the fourth mark image 220d is displayed, for example, in a blinking manner. By changing the display of the fourth mark image 220d over time, the user can easily check the first grid point 147a.

The mark image 220 may be an image in which any one of the brightness, the color degree, and the transmittance changes over time.

Since the mark image 220 changes over time, the user can easily grasp a position of the mark image 220.

### Fifth Embodiment

A fifth embodiment discloses display control of changing a display mode of the grid line 145. The fifth embodiment discloses display control of displaying an auxiliary image 230 in addition to the mark image 220. The control unit 43 performs the display control of displaying the auxiliary image 230.

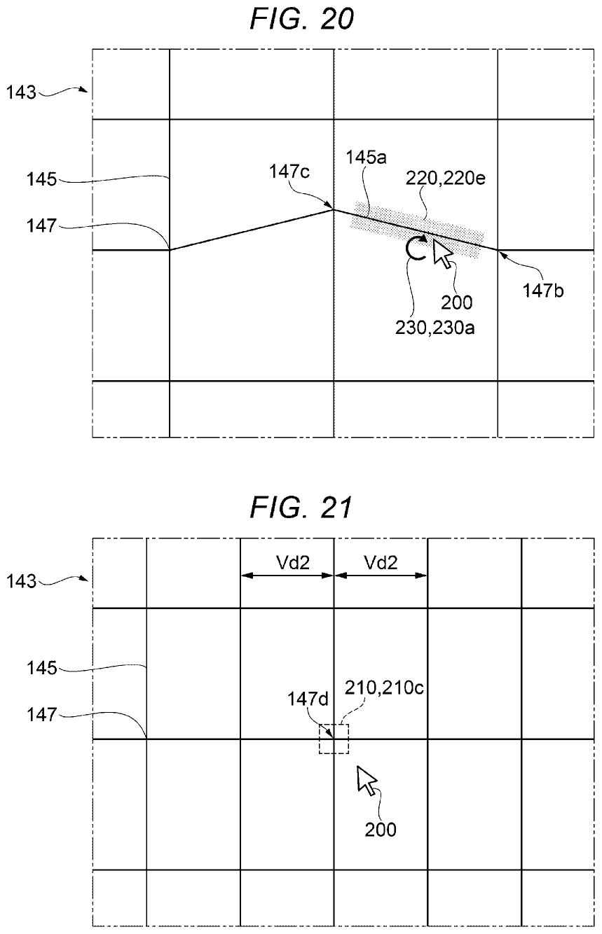

FIG. 19 illustrates a schematic configuration when a part of the preview image 143 is displayed in an enlarged manner. FIG. 19 illustrates a display mode of the first grid line 145a when a state change operation is received. FIG. 19 illustrates the display mode of the first grid line 145a when a grid line selection operation as an example of the state change operation is received.

When a user performs the grid line selection operation on the first grid line 145a by using the mouse 90b, the mouse 90b transmits input data to the input and output unit 49. The input data includes an operation signal corresponding to the grid line selection operation. The input and output unit 49 receives the input data. The input and output unit 49 receives the grid line selection operation by receiving the input data. The input and output unit 49 transmits the input data to the execution unit 45.

The execution unit 45 receives the input data. The execution unit 45 acquires an operation signal included in the input data. The execution unit 45 determines that the operation signal is a selection instruction for the first grid line 145a. The execution unit 45 shifts the first grid line 145a from a grid line unselected state to a grid line selected state. The execution unit 45 transmits the selection instruction to the screen controller 48.

The screen controller 48 receives the selection instruction for the first grid line 145a. The screen controller 48 performs display control of changing the display mode of the first grid line 145a. The screen controller 48 generates screen data for changing the display mode of the first grid line 145a. The screen controller 48 transmits the generated screen data to the display 80 via the input and output unit 49. The screen controller 48 displays a fifth mark image 220e on the first grid line 145a in a superimposed manner. The fifth mark image 220e is an example of the mark image 220. The screen controller 48 performs display control of displaying the fifth mark image 220e on the first grid line 145a. The screen controller 48 changes the display mode of the first grid line 145a by displaying the fifth mark image 220e on the first grid line 145a. FIG. 19 illustrates a state where the fifth mark image 220e is displayed on the first grid line 145a in a superimposed manner. The fifth mark image 220e is displayed at a position corresponding to the second cursor detection region 210b of the first grid line 145a. The second cursor detection region 210b is not illustrated.

When the cursor tip 200a is located in the second cursor detection region 210b, the screen controller 48 displays a first auxiliary image 230a. The first auxiliary image 230a is a rotational movement presentation image indicating that rotational movement processing can be performed. The first auxiliary image 230a is an example of the auxiliary image 230. The screen controller 48 performs display control of displaying the first auxiliary image 230a. The first auxiliary image 230a is displayed at a position adjacent to the cursor 200. The first auxiliary image 230a may be displayed on the fifth mark image 220e. The auxiliary image 230 including the first auxiliary image 230a corresponds to an example of a guide image.

The first auxiliary image 230a guides grid line processing that can be executed on the first grid line 145a. The auxiliary image 230 guides processing that can be executed on a display image such as the grid line 145. The first auxiliary image 230a illustrated in FIG. 19 indicates that the rotational movement processing can be executed on the first grid line 145a. The user can check an input operation that can be input to the first grid line 145a by checking the first auxiliary image 230a. The rotational movement processing is an example of display image processing. The display image processing corresponds to an example of target image processing.

FIG. 20 illustrates a schematic configuration when a part of the preview image 143 is displayed in an enlarged manner. FIG. 20 illustrates a state where a rotational movement operation is performed on the first grid line 145a. The rotational movement operation is an example of a grid line operation. The first grid line 145a illustrated in FIG. 20 is rotationally moved to a movement position different from a grid line display position of the first grid line 145a illustrated in FIG. 19.

The first grid line 145a is rotationally moved around the second grid point 147b. When the user performs a predetermined input operation on the first grid line 145a, the first grid line 145a is rotationally moved. When the first grid line 145a is rotationally moved, the third grid point 147c, which is one end of the first grid line 145a, is moved. When the third grid point 147c is moved, the grid line 145 adjacent to the first grid line 145a is rotationally moved. The grid line 145 adjacent to the first grid line 145a is the grid line 145 having the third grid point 147c as one end.

The cursor tip 200a of the cursor 200 is located in the second cursor detection region 210b of the first grid line 145a. The fifth mark image 220e is displayed on the first grid line 145a in a superimposed manner. In FIG. 20, the fifth mark image 220e is displayed in a superimposed manner on the first grid line 145a located at the movement position, but is not limited thereto. When the user performs the rotational movement operation on the first grid line 145a, the mark image 220 different from the fifth mark image 220e may be displayed on the first grid line 145a.

When the first grid line 145a is located at the movement position illustrated in FIG. 20, the first auxiliary image 230a is continuously displayed. The first auxiliary image 230a indicates that the rotational movement operation can be performed on the first grid line 145a located at the movement position. The first auxiliary image 230a is continuously displayed when the rotational movement operation can be executed on the first grid line 145a. The first auxiliary image 230a is hidden when the rotational movement operation cannot be executed on the first grid line 145a.

The auxiliary image 230 is not limited to the first auxiliary image 230a illustrated in FIG. 20. The auxiliary image 230 is appropriately displayed corresponding to the grid line processing. The auxiliary image 230 includes a selection release presentation image indicating that selection release processing can be performed, a lock presentation image indicating that lock processing can be performed, and the like.

A display control method further includes displaying the first auxiliary image 230a for guiding the grid line processing for the first grid line 145a when the first grid line 145a is in the grid line selected state.

The user can check the grid line processing that can be executed on the first grid line 145a.

### Sixth Embodiment

A sixth embodiment discloses display control of changing a display mode of the grid point 147. The sixth embodiment discloses display control of displaying the auxiliary image 230 in addition to the mark image 220. The sixth embodiment discloses the display control of displaying a second auxiliary image 230b different from the auxiliary image 230 disclosed in the fifth embodiment. The control unit 43 performs the display control of displaying the auxiliary image 230.

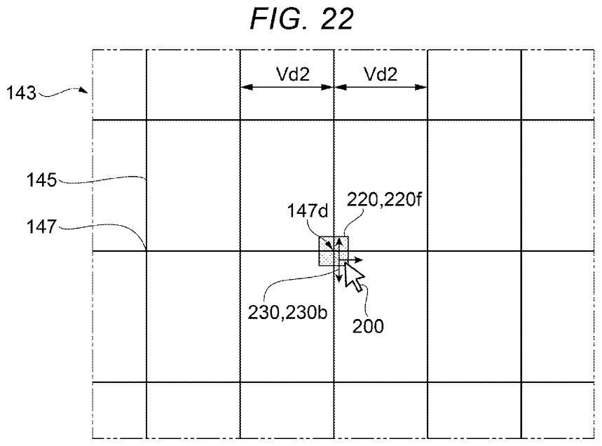

FIG. 21 illustrates a schematic configuration when a part of the preview image 143 is displayed in an enlarged manner. FIG. 21 illustrates a part of the preview image 143 illustrated in FIG. 6 in an enlarged manner. FIG. 21 illustrates a plurality of grid lines 145, a plurality of grid points 147, and the cursor 200. The grid lines 145 extending along a vertical axis are arranged at a second inter-vertical-line distance Vd2. The second inter-vertical-line distance Vd2 is narrower than the first inter-vertical-line distance Vd1 illustrated in FIG. 8. FIG. 21 illustrates a fourth grid point 147d which is one of the plurality of grid points 147.

FIG. 21 virtually illustrates a third cursor detection region 210c that is the cursor detection region 210 of the fourth grid point 147d. The third cursor detection region 210c is a region where a grid point operation for the fourth grid point 147d can be received. The third cursor detection region 210c includes a grid point display position where the fourth grid point 147d is displayed. The third cursor detection region 210c may be controlled by the second inter-vertical-line distance Vd2. When the cursor tip 200a of the cursor 200 is located in the third cursor detection region 210c, a user can execute a grid point selection operation on the fourth grid point 147d. The execution unit 45 receives the grid point selection operation for the fourth grid point 147d performed by the user. The third cursor detection region 210c corresponds to an example of a control region.

FIG. 22 illustrates a schematic configuration when a part of the preview image 143 is displayed in an enlarged manner. FIG. 22 illustrates a display mode of the fourth grid point 147d when the grid point selection operation which is an example of a state change operation is received.

When the user performs the grid point selection operation on the fourth grid point 147d by using the mouse 90b, the mouse 90b transmits input data to the input and output unit 49. The input data includes an operation signal corresponding to the grid point selection operation. The input and output unit 49 receives the input data. The input and output unit 49 receives the grid point selection operation by receiving the input data. The input and output unit 49 transmits the input data to the execution unit 45.

The execution unit 45 receives the input data. The execution unit 45 acquires the operation signal included in the input data. The execution unit 45 determines that the operation signal is a selection instruction for the fourth grid point 147d. The execution unit 45 shifts the fourth grid point 147d from a grid point unselected state to a grid point selected state. The execution unit 45 transmits the selection instruction to the screen controller 48.

The screen controller 48 receives the selection instruction for the fourth grid point 147d. The screen controller 48 performs display control of changing the display mode of the fourth grid point 147d. The screen controller 48 generates screen data for changing the display mode of the fourth grid point 147d. The screen controller 48 transmits the generated screen data to the display 80 via the input and output unit 49. The screen controller 48 displays a sixth mark image 220f on the fourth grid point 147d in a superimposed manner. The sixth mark image 220f is an example of the mark image 220. The screen controller 48 performs display control of displaying the sixth mark image 220f on the fourth grid point 147d. The screen controller 48 changes the display mode of the fourth grid point 147d by displaying the sixth mark image 220f on the fourth grid point 147d. FIG. 22 illustrates a state where the sixth mark image 220f is displayed on the fourth grid point 147d in a superimposed manner. The sixth mark image 220f is displayed at a position corresponding to the third cursor detection region 210c of the fourth grid point 147d. The sixth mark image 220f may be the same as or different from the first mark image 220a.

When the cursor tip 200a is located in the third cursor detection region 210c, the screen controller 48 displays the second auxiliary image 230b. The second auxiliary image 230b is a movement presentation image indicating that movement processing can be performed. The second auxiliary image 230b is an example of the auxiliary image 230. The screen controller 48 performs the display control of displaying the second auxiliary image 230b. The second auxiliary image 230b may be displayed at a position adjacent to the cursor 200. The second auxiliary image 230b may be displayed on the sixth mark image 220f. The second auxiliary image 230b corresponds to an example of a guide image.

The second auxiliary image 230b indicates a movement direction in which the fourth grid point 147d can be moved. The second auxiliary image 230b illustrated in FIG. 22 indicates that the fourth grid point 147d can be moved in upward, downward, and rightward directions of the preview image 143. When the second inter-vertical-line distance Vd2 is shorter than a predetermined distance, the second auxiliary image 230b illustrated in FIG. 22 is displayed. The second auxiliary image 230b indicates that the fourth grid point 147d cannot be moved leftward. The screen controller 48 displays the auxiliary image 230 indicating movable directions according to a position of the grid point 147. By checking the auxiliary image 230, the user can grasp directions in which the grid point 147 can be moved and directions in which the grid point 147 cannot be moved.

The execution unit 45 determines the directions in which the grid point 147 can be moved based on the second inter-vertical-line distance Vd2. The execution unit 45 transmits the determined movable directions to the screen controller 48. The screen controller 48 generates the auxiliary image 230 based on the received movable directions. The screen controller 48 transmits screen data including the generated auxiliary image 230 to the display 80 via the input and output unit 49. The screen controller 48 displays the generated auxiliary image 230 on the display 80.

The auxiliary image 230 is not limited to the second auxiliary image 230b illustrated in FIG. 22. A form of the auxiliary image 230 is appropriately controlled by the execution unit 45 and the screen controller 48. The form of the auxiliary image 230 is controlled by coordinates of the grid point 147, a distance between the adjacent grid points 147, and the like. The form of the auxiliary image 230 may be changed while the user moves the grid point 147. The form of the auxiliary image 230 may be changed according to coordinates of the grid point 147 in a middle of the movement, the distance between the adjacent grid points 147, and the like.

### Seventh Embodiment

A seventh embodiment discloses display control of changing a display mode of the grid line 145. The seventh embodiment discloses display control of displaying the auxiliary image 230. The seventh embodiment illustrates the display control of displaying a third auxiliary image 230c different from the auxiliary image 230 illustrated in the fifth embodiment. The control unit 43 performs the display control of displaying the auxiliary image 230.

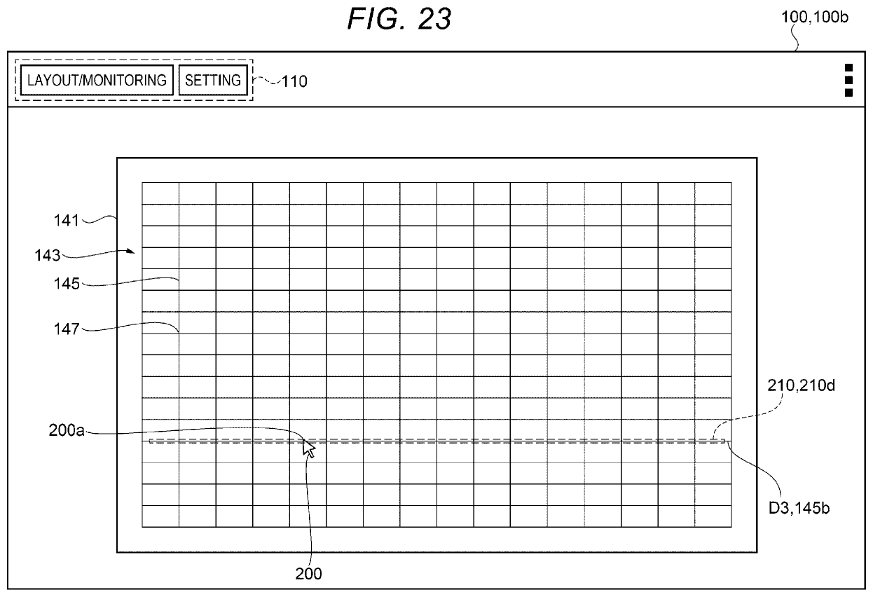

FIG. 23 illustrates a configuration of the management screen 100. FIG. 23 illustrates the second management screen 100b as an example of the management screen 100. The second management screen 100b illustrated in FIG. 23 has the same configuration as that of the second management screen 100b illustrated in FIG. 7. The second management screen 100b is displayed on the display 80 under the control of the display control device 40. The second management screen 100b is displayed on the display 80 when the display control device 40 executes the image adjustment program AP. The second management screen 100b is a screen displayed when geometric distortion correction is performed.

FIG. 23 illustrates a second grid line 145b that is one of a plurality of grid lines 145. FIG. 23 illustrates all of the grid lines 145 extending along a horizontal axis as the second grid line 145b. The second grid line 145b illustrated in FIG. 23 is in a grid line selected state by a grid line selection operation performed by a user. The second grid line 145b is displayed in third display D3. The third display D3 is a display mode different from those of the grid lines 145 other than the second grid line 145b. FIG. 23 illustrates a fourth cursor detection region 210d of the second grid line 145b. The fourth cursor detection region 210d is controlled by the execution unit 45. The fourth cursor detection region 210d is set to include a grid line display position where the second grid line 145b is displayed. The fourth cursor detection region 210d corresponds to an example of a control region.

When the user moves the cursor tip 200a into the fourth cursor detection region 210d, the second grid line 145b is selectable. The fourth cursor detection region 210d is a region where the grid line selection operation for the second grid line 145b can be received. When the user performs the grid line selection operation by using the input device 90, the second grid line 145b is selected. The selected second grid line 145b is shifted from a grid line unselected state to a grid line selected state. The grid line selection operation is, for example, a click operation using the mouse 90b. When the grid line selection operation is performed by the user, input data corresponding to the grid line selection operation is transmitted from the input device 90 to the input and output unit 49. The input data corresponding to the grid line selection operation includes coordinate information on the cursor tip 200a when the grid line selection operation is performed. The input and output unit 49 receives the input data corresponding to the grid line selection operation.

The input and output unit 49 transmits the received input data corresponding to the grid line selection operation to the execution unit 45. The execution unit 45 receives the input data corresponding to the grid line selection operation. The execution unit 45 acquires the coordinate information included in the input data corresponding to the grid line selection operation. The execution unit 45 determines, based on the acquired coordinate information, the grid line 145 on which the grid line selection operation is performed. When the execution unit 45 determines that the grid line 145 on which the grid line selection operation is performed is the second grid line 145b, the execution unit 45 shifts the second grid line 145b from the grid line unselected state to the grid line selected state. The execution unit 45 transmits a selection instruction to the screen controller 48.

The screen controller 48 receives the selection instruction for the second grid line 145b. The screen controller 48 performs display control of changing a display mode of the second grid line 145b. The screen controller 48 generates screen data for changing the display mode of the second grid line 145b. The screen controller 48 transmits the generated screen data to the display 80 via the input and output unit 49. The screen controller 48 displays the second grid line 145b in the third display D3. The screen controller 48 performs the display control of displaying the second grid line 145b in the third display D3. The screen controller 48 changes the display mode of the second grid line 145b by displaying the second grid line 145b in the third display D3.

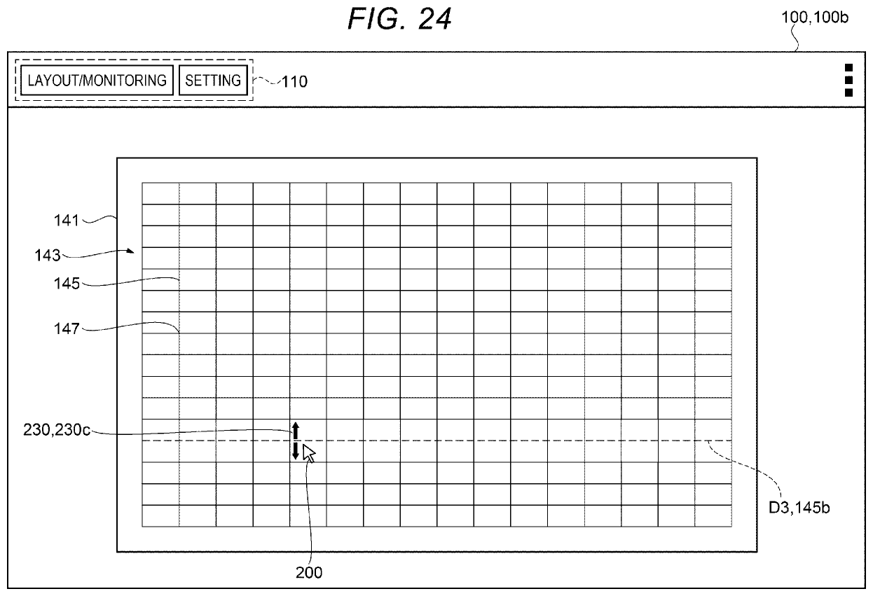

FIG. 24 illustrates a configuration of the management screen 100. FIG. 24 illustrates the second management screen 100b as an example of the management screen 100. FIG. 24 illustrates a display mode of the second grid line 145b when the grid line selection operation is received.

When the cursor tip 200a is located in the fourth cursor detection region 210d, the screen controller 48 displays the third auxiliary image 230c. The third auxiliary image 230c is a movement presentation image indicating that parallel movement processing can be performed. The third auxiliary image 230c is an example of the auxiliary image 230. The screen controller 48 performs the display control of displaying the third auxiliary image 230c. The third auxiliary image 230c is displayed at a position adjacent to the cursor 200. The third auxiliary image 230c corresponds to an example of a guide image.

The third auxiliary image 230c indicates a movement direction in which the second grid line 145b can be parallelly moved. The third auxiliary image 230c illustrated in FIG. 24 indicates that the second grid line 145b can be parallelly moved upward and downward of the preview image 143. The third auxiliary image 230c indicates that the second grid line 145b cannot be moved rightward and leftward. The screen controller 48 displays the auxiliary image 230 indicating parallel movable directions according to a position of the grid line 145. By checking the auxiliary image 230, the user can grasp directions in which the grid line 145 can be moved and directions in which the grid line 145 cannot be moved.

The execution unit 45 determines directions in which the second grid line 145b can be parallelly moved. The execution unit 45 transmits the determined parallel movable direction to the screen controller 48. The screen controller 48 generates the third auxiliary image 230c based on the received parallel movable direction. The screen controller 48 transmits screen data including the generated third auxiliary image 230c to the display 80 via the input and output unit 49. The screen controller 48 displays the generated third auxiliary image 230c on the display 80.

The present disclosure will be summarized as follows.

### Appendix 1

A display control method according to the present disclosure includes: changing a display mode of a target image when an instruction image is located in a control region of the target image that includes a display position where the target image is displayed, the target image being one of a plurality of control images for correcting a projection image projected by a projector.

A user can check whether the target image is a desired control image by visually recognizing the target image whose display mode is changed. By checking that the target image whose display mode is changed is the desired control image, the user can check that the instruction image is located at a desired position.

### Appendix 2

The display control method according to the present disclosure is directed to the display control method according to Appendix 1, in which changing the display mode of the target image includes displaying an index image on the target image in a superimposed manner.

Since the index image is displayed on the target image in a superimposed manner, the user can easily and visually recognize a position of the target image.

### Appendix 3

The display control method according to the present disclosure is directed to the display control method according to Appendix 2, in which the index image is a transparent image through which the target image is visually recognized.

Since the user can visually recognize the index image and the target image, the user can easily grasp whether the target image is the desired control image.

### Appendix 4

The display control method according to the present disclosure is directed to the display control method according to Appendix 2 or 3, in which the index image is an image whose any one of brightness, a color degree, and a transmittance changes over time.

Since the index image changes over time, the user can easily grasp the position of the target image on which the index image is superimposed.

### Appendix 5

The display control method according to the present disclosure is directed to the display control method according to any one of Appendixes 1 to 4, and further includes: shifting the target image from a first state to a second state different from the first state when the instruction image is located in the control region and an image operation is performed on the target image.

A control device can perform control corresponding to a state of the target image.

### Appendix 6

The display control method according to the present disclosure is directed to the display control method according to Appendix 5, and further includes: changing the display mode of the target image to a display mode indicating that the target image is in the second state when the target image is shifted to the second state.

The user can check that the target image is shifted to the second state.

### Appendix 7

The display control method according to the present disclosure is directed to the display control method according to Appendix 5 or 6, and further includes: displaying a guide image for guiding target image processing for the target image when the target image is in the second state.

The user can check the target image processing that can be executed on the target image.

### Appendix 8

A control device according to the present disclosure includes: one or more processors configured to display an instruction image and a plurality of control images for correcting a projection image projected by a projector, and change a display mode of a target image when the instruction image is located in a control region of the target image that includes a display position where the target image is displayed, the target image being one of the plurality of control images; and an interface circuit configured to receive an operation for the instruction image.

The user of the control device can check whether the target image is the desired control image by visually recognizing the target image whose display mode is changed. By checking that the target image is the desired control image, the user can check that the instruction image is located at the desired position.

### Appendix 9

A non-transitory computer-readable storage medium stores a program according to the present disclosure, and the program causes a processor to: display an instruction image and a plurality of control images for correcting a projection image projected by a projector; receiving an operation for the instruction image; and change a display mode of a target image when the instruction image is located in a control region of the target image that includes a display position where the target image is displayed, the target image being one of the plurality of control images.

The user who causes the program to be executed can check whether the target image is the desired control image by visually recognizing the target image whose display mode is changed. By checking that the target image is the desired control image, the user can check that the instruction image is located at the desired position.

What is claimed is:

1. A display control method comprising:
changing a display mode of a target image when an instruction image is located in a control region of the target image that includes a display position where the target image is displayed, the target image being one of a plurality of control images for correcting a projection image projected by a projector.

2. The display control method according to claim 1, wherein
changing the display mode of the target image includes displaying an index image which is superimposed on the target image.

3. The display control method according to claim 2, wherein
the index image is a transparent image through which the target image is visually recognized.

4. The display control method according to claim 2, wherein
the index image is an image whose any one of brightness, a color degree, and a transmittance changes over time.

5. The display control method according to claim 1, further comprising:
shifting the target image from a first state to a second state different from the first state when the instruction image is located in the control region and an operation is performed on the target image.

6. The display control method according to claim 5, further comprising:
changing the display mode of the target image to a display mode indicating that the target image is in the second state when the target image is shifted to the second state.

7. The display control method according to claim 5, further comprising:
displaying a guide image for guiding target image processing for the target image when the target image is in the second state.

8. A control device comprising:
one or more processors programmed to
display an instruction image and a plurality of control images for correcting a projection image projected by a projector, and
change a display mode of a target image when the instruction image is located in a control region of the target image that includes a display position where the target image is displayed, the target image being one of the plurality of control images; and
an interface circuit which receives an operation for the instruction image.

9. A non-transitory computer-readable storage medium storing a program, the program causing a processor to:
display an instruction image and a plurality of control images for correcting a projection image projected by a projector;
receive an operation for the instruction image; and
change a display mode of a target image when the instruction image is located in a control region of the target image that includes a display position where the target image is displayed, the target image being one of the plurality of control images.
